(19) United States
(12) Patent Application Publication
(10) Pub. No.: US 2025/0208528 A1
(43) Pub. Date: Jun. 26, 2025

(54) TONER

(71) Applicant: CANON KABUSHIKI KAISHA, Tokyo (JP)

(72) Inventors: MEGUMI YAMAUCHI, Shizuoka (JP); YUHEI TERUI, Shizuoka (JP); TATSUYA SAEKI, Shizuoka (JP)

(21) Appl. No.: 18/982,051

(22) Filed: Dec. 16, 2024

(30) Foreign Application Priority Data
Dec. 21, 2023 (JP) 2023-215482

(51) Int. Cl. G03G 9/087; C08G 63/16

(52) U.S. Cl. CPC G03G 9/08755; C08G 63/16

(57) ABSTRACT

A toner having a toner particle including a binder resin, wherein the toner particle includes a compound A having a specific polyether structure and an ester wax, the binder resin includes a polyester resin, the polyester resin has a monomer unit corresponding to dodecenylsuccinic acid, and the ester wax has an SP value (cal/cm³)^{0.5} of 8.70 to 9.00.

### BACKGROUND OF THE INVENTION

### Field of the Invention

The present disclosure relates to a toner for developing electrostatic images used in image forming devices such as electrophotography and electrostatic printing devices.

### Description of the Related Art

Laser printers and copiers are representative electrophotography devices that use toners. In recent years, a demand has been created for high productivity, particularly for laser printers, in addition to stable image quality. As for means for increasing productivity, by achieving both excellent charge rising performance and low-temperature fixability, the speed until the initial printout is improved, and by maintaining the built-up charge, stable image quality can be provided.

Methods for improving low-temperature fixability include designing a toner binder resin with a low glass transition temperature (Tg), reducing the molecular weight of the toner binder resin to reduce the melt viscosity, and using the plasticizing effect of a crystalline material that is compatible with the toner binder resin. However, these methods have the problem that image quality changes significantly due to the occurrence of relaxation phenomena in the toner binder resin itself or in materials compatible with the toner binder resin.

In Japanese Patent Application Publication No. 2021-001975, the acid value/hydroxyl value of an ester composition is adjusted to increase the affinity with a toner binder resin, thereby improving low-temperature fixability, hot offset resistance, and durability. In addition, a method is proposed in which the ester composition crystallizes at normal temperature, thereby improving storage stability.

In Japanese Patent Application Publication No. 2020-109500, the SP value of an organosilicon polymer, the domain diameter and SP value of an ester wax, and the SP value of a binder resin are controlled to increase compatibility thereof, thereby improving low-temperature fixability. Furthermore, durability is improved by controlling the crosslink density of the organosilicon polymer.

In Japanese Patent Application Publication No. 2018-081259, the melting point of a crystalline polyester resin is controlled by a resin composition to improve low-temperature fixability, and the melting property of the toner can be controlled by controlling the content of block polymer, the resin composition, and the molecular weight. This reduces density unevenness and gloss unevenness of image and improves image quality.

In addition, in Japanese Patent Application Publication No. 2020-154224, a toner base particle includes a nonionic surfactant to improve the dispersibility of each material that constitutes the toner, and the toner includes tin oxide particles as an external additive to control the charging performance. As a result, the color streak suppression is excellent even when continuous printing is performed after the toner has been allowed to stand in a high-temperature and high-humidity environment.

### SUMMARY OF THE INVENTION

However, the above-mentioned documents have problems in obtaining even higher speeds and stable image quality.

In Japanese Patent Application Publication No. 2021-001975, it is necessary to adjust the acid value/hydroxyl value of the ester wax and increase the affinity with the toner binder resin to improve low-temperature fixability, hot offset resistance, and durability. However, increasing the affinity between the ester wax and the toner binder resin creates the problems of reduced charge rising performance and the occurrence of variation in image quality between the initial image and the image after continuous printing.

In Japanese Patent Application Publication No. 2020-109500, it is necessary to control the resin composition of the binder resin and increase the affinity between the toner binder resin and the ester wax to improve low-temperature fixability. However, increasing the affinity between the ester wax and the toner binder resin creates the problems of reduced charge rising performance and the occurrence of variation in image quality between the initial image and the image after continuous printing, as in Japanese Patent Application Publication No. 2021-001975.

One means for improving the low-temperature fixability in Japanese Patent Application Publication No. 2018-081259, is to increase the amount of wax added. However, although increasing the amount of wax added improves low-temperature fixability, it also increases compatibility with the toner binder resin, and as in Japanese Patent Application Publication No. 2021-001975 and Japanese Patent Application Publication No. 2020-109500, the charging performance is significantly reduced, and image stability and image density uniformity are reduced.

In addition, in Japanese Patent Application Publication No. 2020-154224, a nonionic surfactant is included in the toner and tin oxide particles are added as an external additive, thereby controlling the charging performance and ensuring excellent color streak suppression even when continuous printing is performed after the toner has been allowed to stand in a high-temperature and high-humidity environment. However, in the case of the toner configuration described in Japanese Patent Application Publication No. 2020-154224, compatibility between the wax and the binder resin is low, and low-temperature fixability may be insufficient.

Thus, the present disclosure provides a toner that has excellent low-temperature fixability and excellent charging characteristics such as image stability and image density uniformity during continuous printing.

The present disclosure relates to a toner comprising a toner particle comprising a binder resin, wherein the toner particle comprises an ester wax, and a compound A, which is at least one compound selected from the group consisting of compounds represented by a following formula (1) and compounds represented by a following formula (2), the binder resin comprises a polyester resin, the polyester resin comprises a monomer unit corresponding to dodecenylsuccinic acid, and the ester wax has an SP value (cal/cm³)^{0.5} of 8.70 to 9.00.

R¹—O-(A1-O)ₙ-X (1)

In formula (1), R¹ represents an alkyl group having 8 to 24 carbon atoms, A1 represents an ethylene group or a propylene group, n is an integer from 5 to 60, and X is H, CH₂COOH, CH₂SO₃H, CH₂COONa, or CH₂SO₃Na.

R²-Ph—O-(A2-O)ₘ-X (2)

In formula (2), R² represents an alkyl group having 8 to 24 carbon atoms, Ph represents a phenylene group, A2 represents an ethylene group or a propylene group, m is an integer from 5 to 60, and X is H, CH₂COOH, CH₂SO₃H, CH₂COONa, or CH₂SO₃Na.

According to the present disclosure, a toner can be provided that has excellent low-temperature fixability and excellent charging characteristics such as image stability and image density uniformity during continuous printing.

Further features of the present invention will become apparent from the following description of exemplary embodiments.

### DESCRIPTION OF THE EMBODIMENTS

In the present disclosure, “from XX to YY” or “XX to YY” indicating a numerical range means a numerical range including a lower limit and an upper limit that are end points unless otherwise specified. In a case where numerical ranges are described in stages, an upper limit and a lower limit of each numerical range can be combined as desired.

Furthermore, in the present disclosure, for example, description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ.

In order to obtain a toner that has excellent low-temperature fixability and charging characteristics and also excels in image stability and image density uniformity during continuous printing, the inventors have conducted extensive research into the charging performance and compatibility of waxes with polyester resins. The inventors have found that the above-mentioned problems can be solved by incorporating a monomer unit corresponding to a specific acid in the polyester resin, controlling the SP value of the ester wax, and further incorporating a compound having a polyether structure in the toner.

That is, the present disclosure relates to a toner comprising a toner particle comprising a binder resin, wherein
the toner particle comprises an ester wax, and a compound A, which is at least one compound selected from the group consisting of compounds represented by the following formula (1) and compounds represented by the following formula (2),
the binder resin comprises a polyester resin,
the polyester resin comprises a monomer unit corresponding to dodecenylsuccinic acid, and
the ester wax has an SP value (cal/cm³)^{0.5} of 8.70 to 9.00.

R¹—O-(A1-O)ₙ-X (1)
(in formula (1), R¹ represents an alkyl group having 8 to 24 carbon atoms, A1 represents an ethylene group or a propylene group, n is an integer from 5 to 60, and X is H, CH₂COOH, CH₂SO₃H, CH₂COONa, or CH₂SO₃Na),

R²-Ph—O-(A2-O)ₘ-X (2)
(in formula (2), R² represents an alkyl group having 8 to 24 carbon atoms, Ph represents a phenylene group, A2 represents an ethylene group or a propylene group, m is an integer from 5 to 60, and X is H, CH₂COOH, CH₂SO₃H, CH₂COONa, or CH₂SO₃Na).

The toner of the present disclosure includes a polyester resin containing a monomer unit corresponding to dodecenylsuccinic acid as a binder resin. The polyester resin improves compatibility with the wax. The monomer unit corresponding to dodecenylsuccinic acid is derived from an alkyl chain and structurally is a low-polarity unit, which has the effect of improving compatibility with low-polarity materials such as ester waxes. In particular, the alkyl chain of dodecenylsuccinic acid can exhibit higher compatibility by being present as a side chain to the polyester molecule. In addition, the charging performance is improved by controlling the SP value (cal/cm³)^{0.5} of the ester wax to 8.70 to 9.00.

The monomer unit corresponding to dodecenylsuccinic acid in the polyester resin has a structure in which dodecenylsuccinic acid forms an ester bond, and is represented, for example, by the following formula (D).

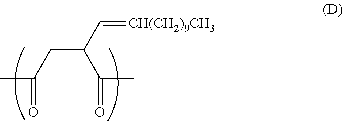

However, with the above-mentioned design alone, overcharging occurs during continuous printing, resulting in low density at the leading end and reduced uniformity in image density. Therefore, an attempt was made to improve charging stability by incorporating a compound having a polyether structure into a toner particle. As a result, it was found that by incorporating compound A, which is at least one compound selected from the group consisting of compounds represented by the following formula (1) and compounds represented by the following formula (2), in the toner particle, in addition to excellent low-temperature fixability, stable charging performance can be obtained even when continuous printing is repeatedly performed.

The inventors presume that this effect is manifested by the following mechanism. The monomer unit corresponding to dodecenylsuccinic acid has a high-polarity succinic acid portion and a low-polarity long-chain alkyl portion. Therefore, the ester wax, which is a low-polarity material, can easily approach the monomer unit corresponding to dodecenylsuccinic acid, and a strong interaction is expressed between the highly polar group portion of dodecenylsuccinic acid and the ester group portion of the ester wax. This interaction produces a portion with a higher polarity. It is believed that this highly polar portion is likely to store charge and contributes to charge retention property.

The polyether structure of compound A also has the function of improving charge mobility within the toner particle, and since the structure of compound A has a high affinity with the polyester resin, the interaction with the polyether segment is favorably expressed. It is presumed that the above mechanism results in excellent charge rising performance and charging stability when continuous printing is repeatedly performed.

Therefore, the SP value (cal/cm³)^{0.5} of the ester wax needs to be from 8.70 to 9.00. Where the SP value of the ester wax is less than 8.70, the interaction with the polyester resin will be weak, impairing the charging performance after continuous printing. Meanwhile, where the SP value of the ester wax is higher than 9.00, the compatibility with the polyester resin will be low, and the fixability will be reduced. Therefore, the SP value of the ester wax needs to be from 8.70 to 9.00, and preferably from 8.80 to 8.90.

In addition, when the toner particle includes compound A, which is at least one compound selected from the group consisting of compounds represented by formula (1) and compounds represented by formula (2), excellent charging stability in continuous printing is achieved. This is due to the improvement of charge mobility within the toner particle, which is derived from the polyether structure of compound A. With the structures of formulas (1) and (2), the affinity with the polyester resin is high and the interaction with the polyether segment is favorably expressed.

R¹—O-(A1-O)ₙ-X (1)

R²-Ph—O-(A2-O)ₘ-X (2)

From the viewpoint of affinity with the polyester resin, in formula (1), R¹ is preferably an alkyl group having 8 to 24 carbon atoms, and more preferably an alkyl group having 10 to 18 carbon atoms. In addition, in formula (2), R² is preferably an alkyl group having 8 to 24 carbon atoms, and more preferably an alkyl group having 9 to 12 carbon atoms. Furthermore, in order to obtain excellent charge mobility within the toner particle, in formula (1), n is preferably from 5 to 60, more preferably from 6 to 30, and even more preferably from 8 to 20. In order to obtain excellent charge mobility, in formula (2), m is preferably from 5 to 60, more preferably from 6 to 30, and even more preferably from 8 to 20.

Where the number of carbon atoms in R¹ and R² is less than the lower limit, the intermolecular interaction between the alkyl groups decreases, and compound A is less likely to approach dodecenylsuccinic acid or ester wax, making it difficult to retain charge inside of the toner, and the charging stability of the toner surface is reduced. This is thought to result in a decrease in density uniformity after continuous printing. In addition, where the number of carbon atoms in R¹ and R² exceeds the upper limit, the molecular weight of compound A becomes too large, making it difficult to move inside of the toner, thereby reducing the charge transport property inside of the toner and lowering the charge rising performance, which is thought to result in a decrease in density stability after continuous printing.

Where n and m are less than the lower limit, the affinity between the polyester resin and compound A decreases, making it difficult to retain charge inside of the toner, and the charging stability of the toner surface is reduced. This is thought to result in a decrease in density uniformity after continuous printing. In addition, where n and m exceed the upper limit, the molecular weight of compound A becomes too large, making it difficult to move inside of the toner, thereby reducing the charge transport property inside of the toner and lowering the charge rising performance, which is thought to result in a decrease in density stability after continuous printing.

In formula (1) or formula (2), A1 or A2 represents an ethylene group (—CH₂CH₂—) or a propylene group (—CH(CH₃)CH₂—), preferably an ethylene group. In formula (1) or formula (2), X represents H, CH₂COOH, CH₂SO₃H, CH₂COONa, or CH₂SO₃Na, preferably H, but may also be CH₂COOH or CH₂SO₃H.

Next, the SP value (cal/cm³)^{0.5} of the ester wax is from 8.70 to 9.00. The molecular weight of the ester wax is, for example, from 500 to 2000, preferably from 500 to 1000, and more preferably from 500 to 800. This is because the ester wax that satisfies the above conditions has excellent compatibility with the polyester resin and a high crystallization rate from the compatible state. As an ester wax that satisfies the above conditions, it is preferable to use an ester wax (diester wax) that has two (bifunctional) or more ester structures in the molecule.

In the present disclosure, the molecular weight of the ester wax is a value calculated from the structure of the ester wax. In addition, in the case of an ester wax having a molecular weight distribution, such as an ester wax derived from a natural product or a synthetic wax using a monomer derived from a natural product or polymer as a monomer component, the peak molecular weight of the molecular weight distribution obtained by GPC analysis is taken as the molecular weight of the ester wax.

Examples of ester waxes include ethylene glycol distearate, ethylene glycol dibehenate, ethylene glycol dipalmitate, 1,4-butanediol distearate, 1,4-butanediol dibehenate, 1,4-butane dipalmitate, 1,6-hexanediol distearate, 1,6-hexanediol dibehenate, 1,6-hexanediol dipalmitate, 1,8-octanediol distearate, 1,8-octanediol dibehenate, 1-8-octanediol dipalmitate, 1,10-decanediol distearate, 1,10-decanediol dibehenate, 1,10-decanediol dipalmitate, distearyl succinate, dipalmityl succinate, dibehenyl succinate, distearyl adipate, dipalmityl adipate, dibehenyl adipate, distearyl suberate, dipalmityl suberate, dibehenyl suberate, distearyl dodecanoate, dipalmityl dodecanoate, dibehenyl dodecanoate, and the like.

Among these, it is preferable that the ester wax contain a diester wax, which is a compound represented by the following formula (3).

R³—COO—R⁵—OCO—R⁴ (3)

(R³ and R⁴ each independently represent an alkyl group having 17 to 22 carbon atoms, and R⁵ represents an alkylene group having 2 to 6 carbon atoms.)

The ester wax of the structure of formula (3) excels in crystallization because the alkyl chains represented by R³ and R⁴ are sufficiently long, and the proportion of included ester groups is sufficient to for compatibility with the polyester resin. Furthermore, because the alkylene chain represented by R⁵ is short, the interaction between the highly polar group portion of the monomer unit corresponding to dodecenylsuccinic acid and the ester group portion of the wax is more strongly expressed. In formula (3), R³ and R⁴ each independently represent an alkyl group having 17 to 22 carbon atoms, and more preferably 17 to 19 carbon atoms, and R⁵ is preferably an alkylene group having 2 to 6 carbon atoms, and more preferably an alkylene group having 2 to 4 carbon atoms.

The melting point of the ester wax is preferably from 60° C. to 90° C.

Furthermore, the content of the ester wax in the toner particle is, for example, from 2.5 parts by mass to 25.0 parts by mass, preferably from 3.0 parts by mass to 20.0 parts by mass, and more preferably from 10.0 parts by mass to 15.0 parts by mass per 100 parts by mass of the binder resin. Within the above ranges, the ester wax has better compatibility with the polyester resin and better low-temperature fixability. In addition, within the above ranges, separation from the state of compatibility with the polyester resin is likely to occur, and crystallization is promoted.

Furthermore, the binder resin may contain a resin other than the polyester resin. In that case, the content ratio of the polyester resin based on the mass of the binder resin is preferably from 50.0% by mass to 100.0% by mass, more preferably from 60.0% by mass to 100.0% by mass, even more preferably from 70.0% by mass to 100.0% by mass, and still more preferably from 85.0% by mass to 100.0% by mass. Within the above ranges, it is easy to obtain better low-temperature fixability and charging performance.

The content ratio of the monomer unit corresponding to dodecenylsuccinic acid based on the mass of the binder resin is, for example, from 2.5% by mass to 22.0% by mass, preferably from 3.0% by mass to 20.0% by mass, and more preferably from 5.0% by mass to 14.0% by mass. Within the above ranges, charging performance is likely to be more stable.

The content ratio of the monomer unit corresponding to dodecenylsuccinic acid in the binder resin can be controlled by adjusting the amount of dodecenylsuccinic acid when producing the binder resin.

The extraction amount of compound A extracted from the toner with ethanol based on the mass of the toner is, for example, from 10 ppm to 1200 ppm, and preferably from 10 ppm to 1000 ppm. In the toner, electric charge is generated by triboelectric charging of the toner particle surface. Where the extraction amount of compound A is within the above ranges, the generated charge becomes uniform on the toner particle surface, and excess electric charge can be efficiently released. The extraction amount is more preferably from 30 ppm to 500 ppm, and even more preferably from 50 ppm to 300 ppm.

The extraction amount of compound A is adjusted according to the amount of compound A added during the toner production step. The timing of adding compound A may be during the toner particle production step or after the toner particle production. From the viewpoint of improving the interaction with the polyester resin, it is preferable to add compound A during the toner particle production step, and from the viewpoint of ensuring uniform presence on the toner particle surface, it is preferable to add compound A in an aqueous medium.

Furthermore, in cross-sectional observation of the toner using a transmission electron microscope, an average ratio of an area occupied by domains of the wax, including the ester wax, in a surface layer region from the surface of the toner particle to a depth of 200 nm is defined as As. In this case, As is from 0.0% by area to 2.0% by area, and preferably from 0.0% by area to 1.0% by area. Here, As being in the above ranges indicates that there is little wax near the toner particle surface.

In the present disclosure, a change in charging performance is suppressed by stabilizing the presence state of the wax after continuous printing by promoting the crystallization of the ester wax, but it is difficult to completely crystallize the ester wax. In particular, since compatible components of the ester wax may remain around the wax domains, by setting As to the above ranges, the migration of compatible components to the toner particle surface can be further suppressed. As is more preferably from 0.0% by area to 0.5% by area.

As can be adjusted by controlling the amount of wax added and the thickness of the shell layer when a toner particle is formed to have a core-shell structure.

It is preferable that the toner particle contain boron atoms. When the content of boron atoms based on the mass of the toner particle is, for example, from 1.0 ppm to 55.0 ppm, preferably from 1.0 ppm to 50.0 ppm, it is easy to obtain a toner particle with excellent charge rising performance and excellent charging stability. Boron atoms have a large ionization potential and easily form covalent bonds, and are, therefore, thought to interact with a large number of ester groups in the polyester resin. It is believed that as a result, the boron atoms are easily dispersed in the polyester resin containing the boron atoms, thereby improving the charge retention property of the toner. Furthermore, it is believed that the interaction between the boron atoms and a large number of ester groups of the polyester resin forms a pseudo-bridged state via the boron atoms, which suppresses the movement of the ester wax that has not been completely crystallized, and makes it possible to obtain a toner with superior charging stability.

The content of boron atoms is more preferably from 3.0 ppm to 30.0 ppm, and even more preferably from 3.0 ppm to 15.0 ppm. Boron atoms can be introduced in the toner particle by adding a compound containing boron atoms during the toner particle production step, and the content can be adjusted by the amount of the compound containing boron atoms added.

### Constituent Components of Toner

The components that make up the toner and the production method of the toner will be explained hereinbelow in more detail.

### Binder Resin

The toner particle includes a binder resin. The binder resin includes a polyester resin. As mentioned above, the binder resin may contain a resin other than the polyester resin. It is preferable that the binder resin contain the polyester resin in an amount of 50% by mass or more. Examples of binder resins other than polyester resin include the following.

There are no particular limitations on the binder resin, but examples thereof include styrene acrylic resins, epoxy resins, polyurethane resins, polyamide resins, cellulose resins, polyether resins, and mixed resins and composite resins thereof. Styrene acrylic resins and polyester resins are preferred because they are inexpensive, easily available, and have excellent low-temperature fixability.

Polyester resins are obtained by selecting and combining suitable ones from polyvalent carboxylic acids, polyols, hydroxycarboxylic acids, and the like, and synthesizing them using a conventionally known method such as a transesterification method or a polycondensation method.

Polyvalent carboxylic acids are compounds that contain two or more carboxy groups in one molecule. Of these, dicarboxylic acids are compounds that contain two carboxy groups in one molecule, and dicarboxylic acids are preferably used.

The polyester resin preferably contains from 3.0% by mass to 20.0% by mass of a monomer unit corresponding to dodecenylsuccinic acid as a polyvalent carboxylic acid. The content of the monomer unit corresponding to dodecenylsuccinic acid is preferably from 5 μmol % to 40 μmol %, and more preferably from 10 μmol % to 25 μmol % out of 100 μmol % of the polyvalent carboxylic acid component of the polyester resin. Examples of polyvalent carboxylic acids other than dodecenylsuccinic acid in the polyester resin are as follows.

Examples of dicarboxylic acids include oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, terephthalic acid, isophthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, cyclohexanedicarboxylic acid, and the like.

Examples of polyvalent carboxylic acids other than dicarboxylic acids include trimellitic acid, trimesic acid, pyromellitic acid, naphthalenetricarboxylic acid, naphthalenetetracarboxylic acid, pyrenetricarboxylic acid, pyrenetetracarboxylic acid, itaconic acid, glutaconic acid, and the like. These may be used alone or in combination of two or more.

Polyols are compounds containing two or more hydroxyl groups in one molecule. Of these, diols are compounds containing two hydroxyl groups in one molecule, and diols are preferably used.

Specific examples include ethylene glycol, diethylene glycol, triethylene glycol, 1,2-propylene glycol, 1,3-propylene glycol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, diethylene glycol, triethylene glycol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, 1,4-cyclohexanediol, polytetramethylene glycol, hydrogenated bisphenol A, bisphenol A, bisphenol F, bisphenol S, alkylene oxide (ethylene oxide, propylene oxide, butylene oxide, and the like) adducts of the above bisphenols, and the like.

Among these, preferred are alkylene glycols having 2 to 12 carbon atoms and alkylene oxide adducts of bisphenols, and particularly preferred are alkylene oxide adducts of bisphenols and combination thereof with alkylene glycols having 2 to 12 carbon atoms.

Examples of trihydric or higher polyols include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and alkylene oxide adducts of the above trivalent or higher polyphenols. These may be used alone or in combination of two or more.

More preferably, the polyvalent carboxylic acid includes at least one selected from the group consisting of terephthalic acid, isophthalic acid, sebacic acid, and trimellitic acid in addition to dodecenylsuccinic acid.

More preferably, the polyol includes at least one selected from the group consisting of an alkylene oxide (ethylene oxide, propylene oxide) adduct (for example, 1 to 10 μmoles, preferably 1 to 5 μmoles) of bisphenol A and an alkylene glycol having 2 to 6 carbon atoms.

The weight-average molecular weight Mw of the polyester resin is preferably from 10,000 to 100,000, and more preferably from 20,000 to 50,000.

The acid value of the polyester resin is preferably from 10.0 μmg KOH/g to 40.0 mg KOH/g, and more preferably from 15.0 μmg KOH/g to 25.0 μmg KOH/g. The hydroxyl value of the polyester resin is preferably from 20.0 μmg KOH/g to 50.0 μmg KOH/g, and more preferably from 25.0 μmg KOH/g to 35.0 μmg KOH/g.

The styrene acrylic resin may be a homopolymer made of the following polymerizable monomers, a copolymer obtained by combining two or more of these, or a mixture thereof.

Styrenic monomers such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene and p-phenylstyrene; (meth)acrylic monomers such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate, 2-benzoyloxyethyl (meth)acrylate, (meth)acrylonitrile, 2-hydroxyethyl (meth)acrylate, (meth)acrylic acid, and maleic acid;
vinyl ether monomers such as vinyl methyl ether and vinyl isobutyl ether;
vinyl ketone monomers such as vinyl methyl ketone, vinyl ethyl ketone, and vinyl isopropenyl ketone; and
polyolefins such as ethylene, propylene, and butadiene.

Polyfunctional polymerizable monomers can be used for the styrene acrylic resin as necessary. Examples of polyfunctional polymerizable monomers include diethylene glycol di(meth)acrylate, triethylene glycol di(meth)acrylate, tetraethylene glycol di(meth)acrylate, polyethylene glycol di(meth)acrylate, 1,6-hexanediol di(meth)acrylate, neopentyl glycol di(meth)acrylate, tripropylene glycol di(meth)acrylate, polypropylene glycol di(meth)acrylate, 2,2′-bis(4-((meth)acryloxydiethoxy)phenyl)propane, trimethylolpropane tri(meth)acrylate, tetramethylolmethane tetra(meth)acrylate, divinylbenzene, divinylnaphthalene, divinyl ether, and the like.

In order to control the degree of polymerization, it is also possible to further add a known chain transfer agent and polymerization inhibitor.

Polymerization initiators for obtaining styrene acrylic resins include organic peroxide initiators and azo polymerization initiators.

Examples of organic peroxide initiators include benzoyl peroxide, lauroyl peroxide, di-α-cumyl peroxide, 2,5-dimethyl-2,5-bis(benzoylperoxy)hexane, bis(4-t-butylcyclohexyl)peroxydicarbonate, 1,1-bis(t-butylperoxy)cyclododecane, t-butylperoxymaleic acid, bis(t-butylperoxy)isophthalate, methyl ethyl ketone peroxide, tert-butylperoxy-2-ethylhexanoate, diisopropyl peroxycarbonate, cumene hydroperoxide, 2,4-dichlorobenzoyl peroxide, and tert-butylperoxypivalate.

Examples of azo polymerization initiators include 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, azobismethylbutyronitrile, and 2,2′-azobis-(methyl isobutyrate).

In addition, redox initiators that combine an oxidizing substance and a reducing substance can also be used as polymerization initiators.

Examples of oxidizing substances include inorganic peroxides such as hydrogen peroxide and persulfates (sodium salts, potassium salts, and ammonium salts), and oxidizing metal salts such as tetravalent cerium salts.

The reducing substances include reducing metal salts (divalent iron salts, monovalent copper salts, and trivalent chromium salts), ammonia, lower amines (amines with from 1 to 6 carbon atoms, such as methylamine and ethylamine), amino compounds such as hydroxylamine, reducing sulfur compounds such as sodium thiosulfate, sodium hydrosulfite, sodium hydrogensulfite, sodium sulfite, and sodium formaldehyde sulfoxylate, lower alcohols (with from 1 to 6 carbon atoms), ascorbic acid or salts thereof, and lower aldehydes (with from 1 to 6 carbon atoms).

The polymerization initiators are selected with reference to a 10-h half-life temperature and are used alone or in combination. The amount of polymerization initiator added varies depending on the desired degree of polymerization, but generally from 0.5 parts by mass to 20.0 parts by mass are added per 100.0 parts by mass of polymerizable monomer.

### Wax

The toner particle includes a wax, and the wax includes an ester wax. In addition to the ester wax, the toner particle may contain other known waxes to the extent that the effect of the present disclosure is not impaired. Specific examples of waxes other than ester waxes include hydrocarbon waxes such as paraffin waxes, microcrystalline waxes, Fischer-Tropsch waxes, polyolefins (for example, polyethylene), petroleum waxes such as petrolatum and derivatives thereof, and montan wax and derivatives thereof.

It is preferable that the wax other than the ester wax contains a hydrocarbon wax. The content of the other wax is preferably from 1.0 parts by mass to 5.0 parts by mass per 100.0 parts by mass of the binder resin.

### Compound A

Compound A is at least one compound selected from the group consisting of compounds represented by the following formula (1) and compounds represented by the following formula (2).

R¹—O-(A1-O)ₙ-X (1)
(in formula (1), R¹ represents an alkyl group having 8 to 24 carbon atoms, A1 represents an ethylene group or a propylene group, n is an integer from 5 to 60, and X is H, CH₂COOH, CH₂SO₃H, CH₂COONa, or CH₂SO₃Na),

R²-Ph—O-(A2-O)ₘ-X (2)
(in formula (2), R² represents an alkyl group having 8 to 24 carbon atoms, Ph represents a phenylene group, A2 represents an ethylene group or a propylene group, m is an integer from 5 to 60, and X is H, CH₂COOH, CH₂SO₃H, CH₂COONa, or CH₂SO₃Na).

A method for producing the above compound is not particularly limited, and any method can be used. For example, the above compound can be obtained by adding a predetermined amount of ethylene oxide or propylene oxide, depending on the purpose, to an aliphatic alcohol. A catalyst can be used for the addition reaction of propylene oxide. As the catalyst, an alkali hydroxide such as NaOH or KOH, or a catalyst containing magnesium oxide as a main component as described in Japanese Patent Application Publication No. H08-323200 can be used. The former makes it possible to obtain a polyethylene alkyl ether or polypropylene alkyl ether having a relatively wide distribution of the number of moles added, and the latter makes it possible to obtain a compound having a relatively narrow distribution of the number of moles added.

Compound A may also be used as a surfactant as exemplified in the method for producing a toner described hereinbelow.

### Colorant

The toner particle may contain a colorant. As the colorant, known pigments and dyes can be used. From the viewpoint of excellent weather resistance, pigments are preferred as the colorant.

Examples of cyan colorants include copper phthalocyanine compounds and derivatives thereof, anthraquinone compounds, basic dye lake compounds, and the like.
Specific examples include the following. C. I. Pigment Blue 1, 7, 15, 15:1, 15:2, 15:3, 15:4, 60, 62, and 66.

Examples of magenta colorants include condensed azo compounds, diketopyrrolopyrrole compounds, anthraquinone compounds, quinacridone compounds, basic dye lake compounds, naphthol compounds, benzimidazolone compounds, thioindigo compounds, perylene compounds, and the like.

Specific examples include the following: C. I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254, and C. I. Pigment Violet 19.

Examples of yellow colorants include condensed azo compounds, isoindolinone compounds, anthraquinone compounds, azo metal complexes, methine compounds, allylamide compounds, and the like.

Specific examples include the following: C. I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Black colorants include those toned to black using the above yellow colorants, magenta colorants, and cyan colorants, as well as carbon black.

These colorants can be used alone or in a mixture, or in the form of a solid solution.

The colorant is preferably used in an amount of from 1.0 parts by mass to 20.0 parts by mass per 100.0 parts by mass of the binder resin.

### Charge Control Agent and Charge Control Resin

The toner particle may contain a charge control agent or a charge control resin. The charge control agent may be any known agent, and is preferably one that has a high triboelectric charging speed and can stably maintain a constant triboelectric charge quantity. Furthermore, when the toner particle is produced by a suspension polymerization method, it is particularly preferable to use a charge control agent that has low polymerization inhibition property and is substantially free of matter solubilizable in an aqueous medium.

Examples of materials that control the toner to be negatively charged include monoazo metallic compounds, acetylacetone metallic compounds, aromatic hydroxycarboxylic acids, aromatic dicarboxylic acids, metallic compounds of hydroxycarboxylic acids and dicarboxylic acids, aromatic mono- and polyvalent carboxylic acids, and metal salts, anhydrides, and esters thereof, phenol derivatives such as bisphenol, urea derivatives, metal-containing salicylic acid compounds, metal-containing naphthoic acid compounds, boron compounds, quaternary ammonium salts, calixarenes, and charge control resins.

Examples of charge control resins include polymers or copolymers having sulfonic acid groups, sulfonic acid salt groups, or sulfonic acid ester groups. As polymers having sulfonic acid groups, sulfonic acid salt groups, or sulfonic acid ester groups, in particular, polymers containing 2% by mass or more of sulfonic acid group-containing acrylamide monomers or sulfonic acid group-containing methacrylamide monomers in a copolymerization ratio are preferred, and polymers containing 5% by mass or more thereof are more preferred.

The charge control resin preferably has a glass transition temperature (Tg) of from 35° C. to 90° C., a peak molecular weight (Mp) of from 10,000 to 30,000, and a weight-average molecular weight (Mw) of from 25,000 to 50,000. When such charge control resin is used, it is possible to impart desirable triboelectric charging properties without affecting the thermal properties required of the toner particle. Furthermore, when the charge control resin contains a sulfonic acid group, for example, the dispersibility of the charge control resin itself in the polymerizable monomer composition and the dispersibility of colorant and the like are improved, and it is possible to further improve the tinting strength, transparency, and triboelectric charging properties.

These charge control agents or charge control resins may be added alone or in combination of two or more types. The amount of the charge control agent or charge control resin added is preferably from 0.01 parts by mass to 20.0 parts by mass, and more preferably from 0.5 parts by mass to 10.0 parts by mass per 100.0 parts by mass of the binder resin.

### Method for Producing Toner

A method for producing the toner is not particularly limited, and known methods such as pulverization, suspension polymerization, solution suspension, emulsion aggregation, and dispersion polymerization can be used. Here, the toner is preferably produced by the emulsion aggregation method.

The method for producing toner includes the following steps (1) to (3) in this order:
(1) A dispersion step of preparing a resin fine particle dispersion liquid including a resin such as a binder resin, and a dispersion step of preparing a wax fine particle dispersion liquid including an ester wax.
(2) An aggregation step for aggregating the resin fine particles contained in the resin fine particle dispersion liquid and the wax fine particles containing the ester wax to form aggregates, and
(3) A fusion step for heating and fusing the aggregates.

It is preferable that the method for producing the toner be such that a boron compound be added in the aggregation step and/or the fusion step.

Furthermore, it is preferable that during or after the fusion step, the following steps (4) to (6) be included in this order:
(4) a sphering step of further raising the temperature and heating the aggregates;
(5) a cooling step of cooling the aggregates at a cooling rate of 0.1° C./sec or more; and
(6) an annealing step of heating and maintaining the aggregates at a temperature equal to or higher than the crystallization temperature or glass transition temperature of the resin.

The toner is preferably produced by the emulsion aggregation method because the toner shape can be controlled and boric acid is easily dispersed uniformly near the surface of the toner. Details of the emulsion aggregation method are explained below.

### Emulsion Aggregation Method

In the emulsion aggregation method, an aqueous dispersion of fine particles made of the constituent materials of the toner particle that are sufficiently small compared to the target particle diameter is prepared in advance, the fine particles are aggregated in an aqueous medium until they reach the particle diameter of the toner particle, and the resin is fused by heating or the like to produce toner particle.

In other words, in the emulsion aggregation method, toner particle is produced through a dispersion step of preparing a fine particle dispersion liquid composed of the constituent materials of the toner particle, an aggregation step of aggregating the fine particles composed of the constituent materials of the toner particle and controlling the particle diameter until the particle diameter becomes the particle diameter of the toner particle, a fusion step of fusing the resin contained in the obtained aggregated particles, a sphering step of further melting by heating or the like and controlling the surface shape of the toner, a subsequent cooling step, a metal removal step of filtering the obtained toner and removing excess polyvalent metal ions, a filtration and washing step of washing with ion-exchanged water or the like, and a step of removing moisture from the washed toner particle and drying.

Step of Preparing Resin Fine Particle Dispersion Liquid (Dispersion Step) The resin fine particle dispersion liquid can be prepared by known methods but is not limited to these methods. Known methods include, for example, an emulsion polymerization method, a self-emulsification method, a phase inversion emulsification method in which a resin is emulsified by adding an aqueous medium to a resin solution obtained by dissolving in an organic solvent, and a forced emulsification method in which a resin is forcibly emulsified by high-temperature treatment in an aqueous medium without using an organic solvent.

Specifically, the resin is dissolved in an organic solvent capable of dissolving the resin, and a surfactant and a basic compound are added. Where the resin is a crystalline resin having a melting point, the resin can be dissolved by heating to or above the melting point thereof. Next, while stirring with a homogenizer or the like, an aqueous medium is slowly added to precipitate resin fine particles. After that, the solvent is removed by heating or reducing pressure to prepare an aqueous dispersion of resin fine particles. Any organic solvent capable of dissolving the resin can be used to dissolve the resin, but from the viewpoint of suppressing the generation of coarse powder, it is preferable to use an organic solvent that forms a homogeneous phase with water, such as toluene.

The surfactant used in the above emulsification is not particularly limited, and examples thereof include anionic surfactants such as sulfuric acid esters and salts, sulfonic acid salts, carboxylic acid salts, phosphoric acid esters, and soap-based surfactants; cationic surfactants such as amine salts and quaternary ammonium salts; and nonionic surfactants such as polyethylene glycols, alkylphenol ethylene oxide adducts, and polyhydric alcohols. The surfactants may be used alone or in combination of two or more kinds.

Examples of the basic compounds used in the dispersion step include inorganic bases such as sodium hydroxide and potassium hydroxide, and organic bases such as ammonia, triethylamine, trimethylamine, dimethylaminoethanol, and diethylaminoethanol. The basic compounds may be used alone or in combination of two or more kinds.

The 50% particle diameter (D50) based on volume distribution of the resin fine particles in the aqueous dispersion of the resin fine particles is preferably from 0.05 μm to 1.0 μm, and more preferably from 0.05 μm to 0.4 μm. By adjusting the 50% particle diameter (D50) based on volume distribution to the above ranges, it becomes easy to obtain toner particle with a volume average particle diameter of 3 μm to 10 μm, which is an appropriate size for toner particle.

The 50% particle diameter (D50) based on the volume distribution is measured using a dynamic light scattering particle diameter distribution analyzer Nanotrac UPA-EX150 (manufactured by Nikkiso Co., Ltd.).

### Wax Fine Particle Dispersion Liquid

A wax fine particle dispersion liquid containing an ester wax can be prepared by the following known methods, but is not limited to these.

A wax fine particle dispersion liquid can be prepared by adding a wax to an aqueous medium containing a surfactant, heating to a temperature equal to or higher than the melting point of the wax, dispersing into particles by using a homogenizer with strong shearing ability (for example, “Clearmix W Motion” manufactured by M Technique Co., Ltd.) or a pressure discharge type disperser (for example, “Gaulin Homogenizer” manufactured by Gaulin Co., Ltd.) and then cooling to below the melting point of the wax.

The dispersed particle diameter of the wax fine particle dispersion liquid in the aqueous dispersion liquid is preferably from 0.03 μm to 1.0 μm, more preferably from 0.1 μm to 0.5 μm, in terms of the 50% particle diameter (D50) based on the volume distribution. It is also preferable that no coarse particles of 1 μm or more be present.

The dispersed particle diameter of the wax fine particle dispersion liquid in the aqueous medium can be measured using a dynamic light scattering particle diameter distribution meter (Nanotrac UPA-EX150, manufactured by Nikkiso Co., Ltd.).

### Colorant Fine Particle Dispersion Liquid

A colorant fine particle dispersion liquid may be used as necessary. A colorant fine particle dispersion liquid can be prepared by the following known methods but is not limited thereto. Thus, the colorant fine particle dispersion liquid can be prepared by mixing a colorant, an aqueous medium, and a dispersing agent with a mixer such as a known stirrer, emulsifier, or disperser. The dispersing agent used here can be a known one such as a surfactant or polymeric dispersing agent.

Both surfactants and polymeric dispersing agents can be removed in the cleaning step described hereinbelow, but surfactants are preferred from the viewpoint of cleaning efficiency.

Surfactants include anionic surfactants such as sulfuric acid esters and salts, sulfonic acid salts, phosphoric acid esters, and soap-based surfactants; cationic surfactants such as amine salts and quaternary ammonium salts; and nonionic surfactants such as polyethylene glycols, alkylphenol ethylene oxide adducts, and polyhydric alcohols. Among these, nonionic surfactants or anionic surfactants are preferred. Nonionic surfactants and anionic surfactants may also be used in combination. The surfactants may be used alone or in combination of two or more. The concentration of the surfactant in the aqueous medium is preferably from 0.5% by mass to 5% by mass.

The content of the colorant fine particles in the colorant fine particle dispersion liquid is not particularly limited, but is preferably from 1% by mass to 30% by mass based on the total mass of the colorant fine particle dispersion liquid.

In addition, from the viewpoint of dispersibility of the colorant in the toner finally obtained, the dispersed particle diameter of the colorant fine particles in the aqueous dispersion of the colorant is preferably 0.5 μm or less in terms of the 50% particle diameter (D50) based on volume distribution. For the same reason, it is preferable that the 90% particle diameter (D90) based on volume distribution be 2 μm or less. The dispersed particle diameter of the colorant particles dispersed in the aqueous medium is measured using a dynamic light scattering particle diameter distribution meter (Nanotrac UPA-EX150, manufactured by Nikkiso Co., Ltd.).

Examples of the conventional mixers such as stirrers, emulsifiers, and dispersers used when dispersing colorants in aqueous media include ultrasonic homogenizers, jet mills, pressure homogenizers, colloid mills, ball mills, sand mills, and paint shakers. These may be used alone or in combination.

### Mixing Step

In the mixing step, a mixed liquid is prepared by mixing a resin fine particle dispersion liquid, a wax fine particle dispersion liquid, and, if necessary, a colorant fine particle dispersion liquid. This can be done using known mixing devices such as a homogenizer and a mixer.

### Step of Forming Aggregate Particles (Aggregation Step)

In the aggregation step, the fine particles contained in the mixed liquid prepared in the mixing step are aggregated to form aggregates of the desired particle diameter. At this time, a flocculant is added and mixed, and heating and/or mechanical power is applied, as appropriate and necessary, to form aggregates in which the resin fine particles, wax fine particles, and colorant fine particles are aggregated.

Examples of the flocculant include organic flocculants such as cationic surfactants of a quaternary salt kind and polyethyleneimine, and inorganic flocculants such as inorganic metal salts such as sodium sulfate, sodium nitrate, sodium chloride, calcium chloride, and calcium nitrate, inorganic ammonium salts such as ammonium sulfate, ammonium chloride, and ammonium nitrate, and divalent or higher metal complexes. It is also possible to add an acid to lower the pH and cause soft aggregation; for example, sulfuric acid or nitric acid can be used.

The flocculant may be added in the form of either a dry powder or an aqueous solution obtained by dissolving in an aqueous medium, but in order to cause uniform aggregation, it is preferable to add the flocculant in the form of an aqueous solution. Furthermore, the addition and mixing of the flocculant is preferably carried out at a temperature equal to or lower than the glass transition temperature or melting point of the resin contained in the mixed liquid. By mixing under this temperature condition, the aggregation proceeds relatively uniformly. The flocculant can be mixed into the mixed liquid by using a known mixing device such as a homogenizer or a mixer. In the aggregation step, aggregates of the toner particle size are formed in an aqueous medium. The volume-average particle diameter of the aggregates produced in the aggregation step is preferably from 3 μm to 10 μm. The volume-average particle diameter can be measured using a particle diameter distribution analyzer (Coulter Multisizer 3, manufactured by Beckman Coulter, Inc.) using the Coulter method.

### Shell Formation Step of Further Adding Resin Fine Particles Containing Shell Resin to Dispersion Liquid Containing Aggregates and Aggregating to Form Aggregates Having Shell

It is preferable to include a shell formation step of further adding resin fine particles containing a shell resin and aggregating them to form shells after forming aggregated particles (core particles) by the aggregation step. That is, it is preferable that the toner particle have a core particle including a binder resin and a shell on the core particle surface. The same resin as the binder resin or a different resin may be used as the shell resin. The amount of the shell resin added is preferably from 5 parts by mass to 40 parts by mass, and more preferably from 10 parts by mass to 35 parts by mass per 100 parts by mass of the binder resin contained in the core particle.

The shell resin is not particularly limited, and the resin described above as the binder resin can be used. The shell resin preferably contains a polyester resin. The shell resin may use a polyester resin having the above-described monomer unit corresponding to dodecenylsuccinic acid.

When forming the shell, it is preferable to further add compound A, together with resin fine particles containing the shell resin, to the dispersion liquid containing the aggregates, thereby including compound A in the toner particle. This is because compound A can be made to be present in the binder resin and on the toner surface by adding compound A when forming the shell.

In addition, when forming the shell, it is preferable to add a boron compound, together with resin fine particles containing the shell resin, to the dispersion liquid containing the aggregates in the shell formation step in order to facilitate the inclusion of boron in the toner particle.

The boron compound may be boric acid or a compound that can be changed to boric acid by pH control or the like during toner production. For example, at least one selected from the group consisting of boric acid, borax, organic boric acids, boric acid salts, boric acid esters, and the like may be used. For example, a boron compound may be added and control may be performed to include boric acid in the aggregate. Preferably, the pH is controlled to an acidic condition in the aggregation step, and the shell formation step is implemented.

In the shell formation step, the presence of boric acid facilitates uniform aggregation of the shell resin on the core particle, thereby making it possible to reduce the area of the domains near the surface.

Boric acid may be present in the aggregate in an unsubstituted state. The boron compound is preferably at least one selected from the group consisting of boric acid and borax. When the toner is produced in an aqueous medium, it is preferable to add a boric acid salt as the boron compound from the viewpoint of reactivity and production stability. Specifically, the boron compound more preferably contains at least one selected from the group consisting of sodium tetraborate, borax, and ammonium borate, and more preferably is borax.

Borax is represented by the decahydrate of sodium tetraborate Na₂B₄O₇, and changes to boric acid in an acidic aqueous solution, so borax is preferably used when a boron compound is to be used in an acidic environment in an aqueous medium. The addition method may include either a dry powder or an aqueous solution obtained by dissolving in an aqueous medium, but it is preferable to add borax in the form of an aqueous solution in order to cause uniform aggregation. The concentration of the aqueous solution may be changed, as appropriate, depending on the concentration of borax to be included in the toner, for example, from 1% by mass to 20% by mass. In order to change borax to boric acid, it is preferable to set the pH to an acidic condition before, during, or after the addition. For example, the pH may be controlled to 1.5 to 5.0, preferably 2.0 to 4.0.

### Step of Obtaining Dispersion Liquid Containing Toner Particle (Fusion Step)

In the fusion step, the aggregation is first stopped, under stirring in the same manner as in the aggregation step, in the dispersion liquid containing the aggregates obtained in the aggregation step. The aggregation is stopped by adding an aggregation stopper such as a base that can adjust the pH, a chelating compound, or an inorganic salt compound such as sodium chloride.

After the dispersion state of the aggregated particles in the dispersion liquid becomes stable due to the action of the aggregation stopper, the dispersion liquid is heated to a temperature equal to or higher than the glass transition temperature or melting point of the resin such as the binder resin, and the aggregated particles are fused and adjusted to the desired particle diameter. The 50% particle diameter (D50) of the toner particle based on volume is preferably from 3 μm to 10 μm.

### Step of Obtaining Desired Surface Shape of Toner (Sphering Step)

During or after the fusion step, it is preferable to carry out a sphering step in which the temperature is further increased and kept until the toner particle has the desired circularity or surface shape. Specific temperatures in the sphering step are, for example, 85° C. or higher, preferably 90° C. or higher, and preferably 95° C. or lower. Examples of heating times in the sphering step include heating times of 1 h or more, 2 h or more, and 3 h or more. The upper limit is, for example, 5 h or less. This step makes it easy to form hydrogen bonds derived from boric acid in the toner particle.

### Cooling Step

After the sphering step, it is preferable to carry out a cooling step in which the temperature of the dispersion liquid containing the obtained toner particle is lowered, by controlling the cooling rate, to a temperature lower than the crystallization temperature or glass transition temperature of the crystalline components of the resin such as the binder resin and the wax such as the hydrocarbon wax and the ester wax. Through the cooling step, it is possible to suppress changes in the domain shape that accompany the crystallization of the crystalline components of the wax. As a result, it becomes easier to control the proportion of the domain area of the crystalline components of the ester wax near the toner particle surface.

The specific cooling rate is 0.1° C./sec or more, preferably 0.5° C./sec or more, more preferably 2° C./sec or more, and even more preferably 4° C./sec or more. The upper limit is, for example, 20° C./sec or less or 15° C./sec or less.

### Annealing Step

After the cooling step, an annealing step may be performed in which the toner particle is heated to a temperature equal to or higher than the crystallization temperature or the glass transition temperature of the resin, and equal to or lower than the crystallization temperature of the wax. Through the annealing step, it is possible to crystallize the crystalline components that were compatibilized with the resin of the toner particle, and further suppresses changes in the domain shape.

### Post-Processing Step

In the method for producing the toner, a post-processing steps such as a washing step, a solid-liquid separation step, and a drying step may be further performed, and dry toner particle is obtained by performing the post-processing step.

### External Addition Step

The toner particle obtained may be used as they are as toner, but in the external addition step, an external additive such as silica fine particles may be externally added to the toner particle obtained in the drying step.

As the external addition conditions, the adhesion state of the external additive and the coating state of the toner particle with the external additive can be controlled as desired by changing the rotation speed rpm of the stirring spring provided in the external addition machine and the external addition time.

In order to make the particles adhere more firmly, it is effective to increase the rotation speed and extend the external addition time, and in particular, the adhesion strength can be increased by increasing the rotation speed. Furthermore, since the external addition particles having a small particle diameter form aggregates, the external addition conditions are controlled to perform a deagglomeration treatment while coating the toner particle with the external additive. Deagglomeration performance can be improved by increasing the rotation speed and extending the external addition time, but in order to further advance deagglomeration while suppressing the adhesion strength, it is effective to reduce the rotation speed and extend the external addition time.

The weight-average particle diameter (D4) of the toner is preferably from 4.0 μm to 12.0 μm, and more preferably from 4.0 μm to 8.0 km.

### Methods for Measuring Physical Properties

Next, methods for measuring physical properties related to the present disclosure will be described.

### Measurement of Weight-Average Particle Diameter (D4) and Number Average Particle Diameter (D1) of Toner or Toner Particle

The weight-average particle diameter (D4) and number-average particle diameter (D1) of toner or toner particle is measured with a precision particle diameter distribution measuring device using a pore electrical resistance method, “Coulter Counter Multisizer 3” (registered trademark, manufactured by Beckman Coulter, Inc.) equipped with a 100 μm aperture tube, and the dedicated software “Beckman Coulter Multisizer 3 Version 3.51” (manufactured by Beckman Coulter, Inc.) provided therewith for setting measurement conditions and analyzing measurement data, with the number of effective measurement channels of 25,000, and the measurement data is analyzed and calculated.

The aqueous electrolytic solution used for the measurement is one in which special grade sodium chloride is dissolved in ion-exchanged water to a concentration of approximately 1% by mass, for example, “ISOTON II” (manufactured by Beckman Coulter, Inc.) can be used.

Before carrying out measurements and analysis, the dedicated software is set up as follows.

In the “Change Standard Measurement Method (SOM) Screen” of the dedicated software, the total count number in control mode is set to 50,000 particles, the number of measurements is set to 1, and the Kd value is set to the value obtained using “Standard Particle 10.0 μm” (manufactured by Beckman Coulter, Inc.). The threshold and noise level are automatically set by pressing the threshold/noise level measurement button. In addition, the current is set to 1600 μA, the gain to 2, the electrolytic solution to ISOTON II, and the aperture tube flush after measurement is checked.

In the “Pulse to Particle Size Conversion Setting Screen” of the dedicated software, the bin interval is set to logarithmic particle size, the particle diameter bin to 256 particle diameter bin, and the particle diameter range to from 2 μm to 60 km.

The specific measurement method is as follows.
(1) Approximately 200 μmL of the aqueous electrolytic solution is poured into a 250 μmL round-bottom glass beaker made exclusively for the Multisizer 3, the beaker is set on a sample stand, and stirring with a stirrer rod is performed counterclockwise at 24 revolutions per second. Then, the “Aperture Tube Flush” function of the dedicated software is used to remove dirt and air bubbles from inside of the aperture tube.
(2) Approximately 30 μmL of the aqueous electrolytic solution is poured into a 100 μmL flat-bottom glass beaker, and approximately 0.3 μmL of a solution prepared by three-fold (by mass) dilution of “Contaminon N” (a 10% aqueous solution of a neutral detergent for cleaning precision measuring instruments that has pH 7 and consists of a nonionic surfactant, an anionic surfactant, and an organic builder, manufactured by Wako Pure Chemical Industries, Ltd.) with ion-exchanged water is added as a dispersing agent.
(3) A predetermined amount of ion-exchanged water is placed in a water tank of an ultrasonic disperser “Ultrasonic Dispersion System Tetora 150” (manufactured by Nikkaki Bios Co., Ltd.) with two built-in oscillators with an oscillation frequency of 50 kHz and an electric output of 120 W that have a phase shift of 180 degrees, and about 2 mL of the Contaminon N is added to the water tank.
(4) The beaker of (2) is set in the beaker fixing hole of the ultrasonic disperser, and the ultrasonic disperser is operated. The height position of the beaker is adjusted so that the resonance state of the liquid surface of the aqueous electrolytic solution in the beaker is maximized.
(5) With the aqueous electrolytic solution in the beaker of (4) irradiated with ultrasonic waves, about 10 μmg of toner or toner particle is added little by little to the aqueous electrolytic solution and dispersed. Then, the ultrasonic dispersion treatment is further continued for 60 sec. During ultrasonic dispersion, the water temperature of the water tank is adjusted, as appropriate, to be from 10° C. to 40° C.
(6) Using a pipette, the aqueous electrolytic solution of (5) in which the toner or toner particle is dispersed is added dropwise to the round-bottom beaker of (1) placed in the sample stand, and the measurement concentration is adjusted to about 5%. The measurement is performed until the number of measured particles reaches 50,000.
(7) The measurement data are analyzed using the dedicated software provided with the device, and the weight-average particle diameter (D4) is calculated. When the dedicated software is set to graph/volume %, the “Average Diameter” on the analysis/volume statistics (arithmetic mean) screen is the weight-average particle diameter (D4), and when the dedicated software is set to graph/number %, the “Average Diameter” on the analysis/number statistics (arithmetic mean) screen is the number-average particle diameter (D1).

### Measurement of Acid Value

Acid value is the number of milligrams of potassium hydroxide required to neutralize an acid contained in 1 g of sample. The acid value of the resin is measured according to JIS K 0070-1992, specifically, according to the following procedure.

### (1) Preparation of Reagents

A total of 1.0 g of phenolphthalein is dissolved in 90 μmL of ethyl alcohol (95% by volume), and ion-exchanged water is added to make 100 μmL and obtain a phenolphthalein solution.

A total of 7 g of special grade potassium hydroxide is dissolved in 5 μmL of water, and ethyl alcohol (95% by volume) is added to make 1 L. The solution is placed in an alkali-resistant container to avoid contact with carbon dioxide and the like, allowed to stand for 3 days, and then filtered to obtain a potassium hydroxide solution. The obtained potassium hydroxide solution is stored in an alkali-resistant container. A total of 25 μmL of 0.1 μmol/L hydrochloric acid is placed in an Erlenmeyer flask, a few drops of the phenolphthalein solution are added, and titrating is performed with the potassium hydroxide solution. The factor of the potassium hydroxide solution is determined from the amount of potassium hydroxide solution required for neutralization. The 0.1 μmol/L hydrochloric acid used is prepared in accordance with JIS K 8001-1998.

### (2) Procedure

### (A) Main Test

A total of 2.0 g of a sample of pulverized resin is weighed out into a 200 μmL Erlenmeyer flask, 100 μmL of a toluene/ethanol (2:1) mixed solution is added, and dissolution is performed for 5 h. Then, a few drops of the phenolphthalein solution are added as an indicator, and titration is performed using the potassium hydroxide solution. The end point of the titration is when the light red color of the indicator continues for 30 sec.

### (B) Blank Test

The titration is performed in the same manner as above, except that no sample is used (that is, only a toluene/ethanol (2:1) mixed solution is used).
(3) The obtained results are substituted into the following formula to calculate the acid value.

$$A = [ ( C - B ) \times f \times 5.61 ] / S$$

Here, A is the acid value (mg KOH/g), B is the amount of potassium hydroxide solution added in the blank test (mL), C is the amount of potassium hydroxide solution added in the main test (mL), f is the factor of the potassium hydroxide solution, and S is the mass of the sample (g).

### Method for Measuring Hydroxyl Value

Hydroxyl value is the number of milligrams of potassium hydroxide required to neutralize acetic acid bonded to the hydroxyl groups when acetylating 1 g of sample. The hydroxyl value of the binder resin is measured according to JIS K 0070-1992, but specifically, according to the following procedure.

### (1) Preparation of Reagents

A total of 25 g of special grade acetic anhydride is placed into a 100 μmL measuring flask, pyridine is added to make the total volume 100 μmL, and the flask is shaken well to obtain the acetylation reagent. The obtained acetylation reagent is stored in a brown bottle to avoid contact with moisture, carbon dioxide, and the like. A total of 1.0 g of phenolphthalein is dissolved in 90 μmL of ethyl alcohol (95% by volume), and ion-exchanged water is added to make 100 μmL and obtain a phenolphthalein solution.

A total of 35 g of special grade potassium hydroxide is dissolved in 20 μmL of water, and ethyl alcohol (95% by volume) is added to make 1 L. The solution is placed in an alkali-resistant container to avoid contact with carbon dioxide and the like, allowed to stand for 3 days, and then filtered to obtain a potassium hydroxide solution. The obtained potassium hydroxide solution is stored in an alkali-resistant container. A total of 25 μmL of 0.5 μmol/L hydrochloric acid is placed in an Erlenmeyer flask, a few drops of the phenolphthalein solution are added, and titration is performed with the potassium hydroxide solution. The factor of the potassium hydroxide solution is determined from the amount of potassium hydroxide solution required for neutralization. The 0.5 μmol/L hydrochloric acid used is prepared in accordance with JIS K 8001-1998.

### (2) Procedure

### (A) Main Test

A total of 1.0 g of sample is accurately weighed into a 200 μmL round-bottom flask, and 5.0 μmL of the acetylation reagent is accurately added thereto using a Hall pipette. In this case, where the sample is difficult to dissolve in the acetylation reagent, a small amount of special grade toluene is added to induce dissolution.

A small funnel is placed on the mouth of the flask, and the flask is heated with about 1 cm of the bottom section immersed in a glycerin bath at about 97° C. In order to prevent the temperature of the flask neck from rising due to the heat of the bath, it is preferable to cover the base of the flask neck with cardboard with a round hole.

After 1 h, the flask is removed from the glycerin bath and allowed to cool. After cooling, 1 μmL of water is added from the funnel and the flask is shaken to hydrolyze the acetic anhydride. To further complete the hydrolysis, the flask is heated again in the glycerin bath for 10 μmin. After cooling, the funnel and flask walls are washed with 5 μmL of ethyl alcohol.

A few drops of the phenolphthalein solution are added as an indicator and titration is performed with the potassium hydroxide solution. The end point of the titration is when the light red color of the indicator continues for about 30 sec.

### (B) Blank Test

The titration is performed in the same manner as above, except that no sample is used.
(3) The obtained results are substituted into the following formula to calculate the hydroxyl value.

$$A = [ \{ ( B - C ) \times 28.05 \times f \} / S ] + D$$

Here, A is the hydroxyl value (mg KOH/g), B is the amount of potassium hydroxide solution added in the blank test (mL), C is the amount of potassium hydroxide solution added for the main test (mL), f is the factor of the potassium hydroxide solution, S is the mass of the sample (g), and D is the acid value of the sample (mg KOH/g).

### Method for Measuring Content Ratio of Monomer Unit Corresponding to Dodecenylsuccinic Acid Based on Mass of Binder Resin

The content ratio of monomer units corresponding to dodecenylsuccinic acid based on the mass of the binder resin is measured using a pyrolysis gas chromatography mass spectrometer (hereinafter referred to as pyrolysis GC/MS) and NMR.

Specifically, the following operations are performed.
(1) A total of 50 μmg of toner is precisely weighed into an 8 μmL glass sample bottle, 1 μmL of deuterated chloroform is added, the bottle is capped, and the toner is dispersed and dissolved for 1 h using an ultrasonic disperser. Next, filtration is performed through a 0.4 μm membrane filter, and the filtrate is collected. At this time, the deuterated chloroform insoluble matter remains on the membrane filter.
(2) ¹H-NMR and ¹³C-NMR measurements are performed on the filtrate, the components contained in the toner are attributed from the spectrum, and the content ratio of the monomer unit corresponding to dodecenylsuccinic acid contained in the toner is calculated.
(3) Where the identification is insufficient, further analysis is performed by pyrolysis GC/MS, and if necessary, a derivatization treatment such as methylation is performed, followed by composition analysis.
(4) The amount of binder resin in the toner is calculated according to the “Method for Measuring Ester Wax Content in Toner” described hereinbelow, and from these values, the content ratio of the monomer unit corresponding to dodecenylsuccinic acid based on the mass of the binder resin can be calculated.

NMR Measurement Conditions
Bruker AVANCE 500, manufactured by Bruker Biospin Co., Ltd.
Measurement nuclei: ¹H, ¹³C
Measurement frequency: 500.1 MHz
Number of integrations: 16, 2048
Measurement temperature: room temperature

Pyrolysis GC/MS Measurement Conditions
Pyrolysis device: TPS-700, manufactured by Japan Analytical Industry Co., Ltd.
Pyrolysis temperature: optimal value at 400° C. to 600° C.
GC/MS device: ISQ manufactured by Thermo Fisher Scientific Inc.
Column: “HP5-MS” (Agilent/19091S-433), length 30 μm, inner diameter 0.25 μmm, membrane thickness 0.25 μm
GC/MS conditions
Inlet conditions:
InletTemp: 250° C.
SplitFlow: 50 μmL/min
GC temperature rise conditions: 40° C. (5 μmin)→10° C./min (300° C.)→300° C. (20 μmin)

### Measurement of Molecular Weight of Polyester Resin

The molecular weight (weight-average molecular weight Mw) of polyester resin is measured by gel permeation chromatography (GPC) in the following manner.

First, the polyester resin is dissolved in tetrahydrofuran (THF) at room temperature for 24 h. The resulting solution is then filtered through a solvent-resistant membrane filter “MyShori Disc” (manufactured by Tosoh Corporation) with a pore size of 0.2 μm to obtain a sample solution. The sample solution is adjusted so that the concentration of components soluble in THF is 0.8% by mass. This sample solution is used for measurements under the following conditions.
Apparatus: HLC8120 GPC (detector: RI) (manufactured by Tosoh Corporation)
Column: Shodex LF-404, LF-404 in series (manufactured by Showa Denko Corporation)
Eluent: tetrahydrofuran (THF)
Flow rate: 1.0 μmL/min
Oven temperature: 40.0° C.
Sample injection volume: 0.10 μmL

To calculate the molecular weight of the sample, a molecular weight calibration curve created using standard polystyrene resins (for example, product names “TSK Standard Polystyrene F-850, F-450, F-288, F-128, F-80, F-40, F-20, F-10, F-4, F-2, F-1, A-5000, A-2500, A-1000, A-500”, manufactured by Tosoh Corporation) are used.

### Identification of Molecular Structure of Ester Wax Contained in Toner

First, the wax contained in the toner is isolated from the toner by the following separation procedure. The toner is dispersed in ethanol, which is a poor solvent for the toner, and the temperature is raised to above the melting point of the wax. At this time, pressure may be applied if necessary. The wax at a temperature that has exceeded the melting point thereof as a result of this procedure is melted and extracted into the ethanol. Where heating and further pressure application are performed, the wax can be separated from the toner by performing solid-liquid separation while still under pressure. Next, the extract is dried and solidified to obtain the wax. By classifying the wax obtained according to molecular weight, the ester wax can be isolated. This separation procedure makes it possible to isolate the ester wax even when a wax other than the ester wax is mixed in.

Next, the molecular structure of the isolated ester wax is identified. A pyrolysis gas chromatography mass spectrometer (hereinafter referred to as pyrolysis GC/MS) and NMR are used to identify the molecular structure.

Specifically, the following procedures are performed.
(1) A total of 50 μmg of toner is precisely weighed into an 8 μmL glass sample bottle, 1 μmL of deuterated chloroform is added, the bottle is capped, and the toner is dispersed and dissolved for 1 h using an ultrasonic disperser. Next, filtration is performed through a 0.4 μm membrane filter, and the filtrate is collected. At this time, the deuterated chloroform insoluble matter remains on the membrane filter.
(2) ¹H-NMR measurement is performed on the filtrate, and a spectrum is attributed to the ester wax.
(3) Analysis is performed by pyrolysis GC/MS. If necessary, a derivatization treatment such as methylation is performed to calculate the molecular weight of the ester wax.

NMR Measurement Conditions
Bruker AVANCE 500, manufactured by Bruker Biospin Co., Ltd.
Measurement nuclei: ¹H
Measurement frequency: 500.1 MHz
Number of integrations: 16
Measurement temperature: room temperature

Pyrolysis GC/MS Measurement Conditions
Pyrolysis device: TPS-700, manufactured by Japan Analytical Industry Co., Ltd.
Pyrolysis temperature: optimal value at 400° C. to 600° C.
GC/MS device: ISQ manufactured by Thermo Fisher Scientific Inc.
Column: “HP5-MS” (Agilent/19091S-433), length 30 μm, inner diameter 0.25 μmm,
membrane thickness 0.25 μm
GC/MS conditions
Inlet conditions:
InletTemp: 250° C.
SplitFlow: 50 μmL/min
GC temperature rise conditions: 40° C. (5 μmin)→10° C./min (300° C.)→300° C. (20 μmin)

### Method for Measuring Ester Wax Content in Toner

The ester wax content W per 100 parts by mass of binder resin in the toner is calculated by the following procedure. First, the mass X1 of the tetrahydrofuran (THF) soluble matter in the toner, the mass X2 of the insoluble matter, and the incineration residue ash content X3 of the insoluble matter are determined. Then, the ester wax content w in the toner can be calculated.

Specifically, 1.5 g of toner is precisely weighed and placed in a pre-weighed cylindrical filter paper (product name: No. 86R, size 28×100 μmm, manufactured by Advantec Toyo Co., Ltd.) which is then set in a Soxhlet extractor. Extraction is performed for 20 h using 200 μmL of tetrahydrofuran (THF) as a solvent. At this time, the extraction is performed at a reflux rate such that the solvent extraction cycle occurs once every 5 μmin. After the extraction is complete, the cylindrical filter paper is removed, air-dried, and then vacuum-dried at 40° C. for 8 h. The mass of the cylindrical filter paper containing the extraction residue is weighed, and the mass of the cylindrical filter paper is subtracted to determine the mass of the extraction residue as the mass X2 (g) of the tetrahydrofuran (THF) insoluble matter in the toner. The mass X1 (g) of the tetrahydrofuran (THF) soluble matter in the toner is calculated using the following formula (A):

$$X 1 = 1.5 - X 2 \qquad ( A )$$

Next, the content X3 (g) of components other than the resin component, is determined according to the following procedure. A total of 1.5 g of toner is precisely weighed into a pre-weighed 30 μmL porcelain crucible. The porcelain crucible is placed in an electric furnace and heated at 900° C. for 3 h, allowed to cool in the electric furnace, and allowed to cool in a desiccator at normal temperature for at least 1 h. The mass of the crucible containing the incineration residue ash is weighed, and the mass of the crucible is subtracted to calculate the incineration residue ash content X3 (g).

Furthermore, the extract obtained by the above operation is filtered through a solvent-resistant membrane filter “MyShori Disc” (manufactured by Tosoh Corporation) with a pore size of 0.2 μm to obtain a sample solution. This sample solution is used for measurements under the following conditions.
Apparatus: HLC8320 GPC (detector: RI) (manufactured by Tosoh Corporation)
Column: Shodex LF-404, LF-404 in series (manufactured by Showa Denko
Corporation)
Eluent: tetrahydrofuran (THF)
Flow rate: 1.0 μmL/min
Oven temperature: 40.0° C.
Sample injection volume: 0.10 μmL

The total area S of the molecular weight distribution of the tetrahydrofuran (THF) soluble matter in the obtained toner and the area P derived from the ester wax having a molecular weight equivalent to that of the wax identified by the above-mentioned method are measured, and the amount w of the ester wax in the toner can be calculated using the following calculation formula (B).

$$w = ( X 1 \times P / S ) = \{ ( 1.5 - X 2 ) \times P / S \} \qquad ( B )$$

Furthermore, the total area S of the molecular weight distribution of the tetrahydrofuran (THF) soluble matter in the toner and the area Pw derived from all waxes can be obtained by the above GPC, and the amount R of the binder resin in the toner can be calculated from the following formula (R).

$$R = \{ X 1 + ( X 2 - X 3 ) \} - ( X 1 \times {P}_{W} / S ) \qquad ( R )$$

The content of the ester wax per 100 parts by mass of binder resin can be determined from the obtained content w of ester wax and amount R of binder resin.

### Method for Calculating SP Value of Ester Wax

The SP value of ester wax was calculated as follows, following the calculation method proposed by Fedors.

When calculating the SP value (cal/cm³)^{0.5} of the ester wax, the evaporation energy (Δei) (cal/mol) and molar volume (Δvi) (cm³/mol) are obtained for the atom or atomic group in the molecular structure of the identified ester wax from the table in “Polym. Eng. Sci., 14(2), 147-154 (1974)”, and the calculation is performed by the following formula (4).

SP value of ester wax=(ΣΔei/ΣΔvi)^{0.5} Formula (4)

Measurement of Extraction Amount of Compound A Extracted with Ethanol

The extraction amount of compound A extracted from the toner with ethanol is determined using ¹H-NMR (nuclear magnetic resonance) measurement in the following manner.

First, 50 μmL of ethanol and 5 g of toner are weighed out and mixed thoroughly in a sample bottle, and then ultrasonic waves are applied for 30 μmin using a tabletop ultrasonic cleaner (product name “B₂₅₁₀JMTH”, manufactured by Branson Co.) with an oscillation frequency of 42 kHz and an electrical output of 125 W. The mixture is then filtered using a solvent-resistant membrane filter “MyShori Disc” (manufactured by Tosoh Corporation) with a pore size of 0.2 μm. The ethanol is removed from the filtrate using an evaporator, and the mixture is dissolved in deuterated chloroform containing 10 μmg of trimethylsilane (TMS) (1% TMS) and analyzed by ¹H-NMR to identify the structure of compound A.

Separately, ¹H-NMR measurements are performed on the identified compound A, and the extraction amount (ppm) of compound A extracted from the toner is calculated using a calibration curve based on TMS intensity. The calibration curve is created from the TMS intensity and the peak intensity ratio derived from the hydrogen of the ethylene oxide group around 3.0 ppm to 5.0 ppm. The measurement device and conditions are as follows.

NMR Measurement Conditions
Bruker AVANCE 500, manufactured by Bruker Biospin Co., Ltd.
Measurement nuclei: ¹H
Measurement frequency: 500.1 MHz
Number of integrations: 1024
Measurement temperature: room temperature
   Calculation of Average Proportion As of Area Occupied by Domains of Wax in Surface Layer Region from Surface of Toner Particle to Depth of 200 nm

The distribution state of the crystallized wax in the toner is evaluated by observing the cross section of the toner particle with a transmission electron microscope, calculating As from the cross-sectional area of the domains formed by the crystallized wax, and averaging over 100 arbitrarily selected toners.

In detail, the toner is embedded in a visible light curable embedding resin (D-800, manufactured by Nissin EM Co., Ltd.), cut to a thickness of 60 nm using an ultrasonic ultramicrotome (EM5, manufactured by Leica), and Ru stained using a vacuum staining device (manufactured by Filgen, Inc.). Subsequent observation is performed using a transmission electron microscope (H7500, manufactured by Hitachi, Ltd.) at an accelerating voltage of 120 kV. For the toner cross sections to be observed, 100 particles within ±2.0 μm of the weight-average particle diameter are selected and photographed. The obtained images are processed using image processing software (Photoshop (registered trademark) 5.0, manufactured by Adobe Inc.) to clearly distinguish the domains of the crystallized wax component from the regions of the resin. In detail, the domains of the crystallized wax component can be distinguished as follows. The captured TEM image is binarized using the image processing software by setting the threshold value of brightness (255 gradations) to 160. At this time, the crystallized wax component of the toner and the photocurable resin D800 become bright areas, and the areas other than the crystalline resin component of the toner become dark areas. The contour of the toner can be distinguished by the brightness/darkness of the toner and the photocurable resin.

Masking is performed to leave the surface layer region of the cross section of the toner particle from the toner particle surface (contour of the cross section) to a depth of 200 nm. In detail, a line is drawn from the center of gravity of the toner particle cross section to a point on the contour of the toner particle cross section. On the line, a position 200 nm from the contour in the direction of the center of gravity is identified. This operation is then performed for one circumference of the contour of the toner particle cross section, and the surface layer region up to 200 nm from the contour of the toner particle cross section is clearly indicated. The percentage of the area occupied by the domains of the crystallized wax component in the area of the obtained surface region is calculated, and this is designated as As.

### Method for Quantifying Boron Atoms Based on Mass of Toner Particle

The content of boron (B) atoms based on the mass of toner particle is quantified using an inductively coupled plasma mass spectrometer (ICP-MS). As a pretreatment, the toner particle is subjected to the following acid decomposition, a measurement solution for ICP-MS is obtained, and then an ICP-MS measurement is performed, so that the content of boron atoms in the toner particle can be quantified.

### Pretreatment

Apparatus: Microwave pretreatment device (ETHOS SEL) manufactured by Milestone General K. K.
Sample amount: 50 μmg

A total of 5.00 μmL of 68% nitric acid (for atomic absorption spectrometry, manufactured by Kanto Chemical Co.) is added to 50 μmg of toner particle, and acid decomposition is performed using the above device. The acid decomposition is performed in two stages to obtain the desired measurement solution for ICP-MS. The acid decomposition conditions are as follows.

### First Stage of Acid Decomposition

The heating temperature and holding time during acid decomposition are set as follows.
Normal temperature, 60° C. (2 μmin), 40° C. (2 μmin), 160° C. (6 μmin), 220° C. (8 μmin), 180° C. (1 μmin), 220° C. (4 μmin), 220° C. (maintained for 30 μmin), cooling to room temperature (25° C.).

### Second Stage of Acid Decomposition

The heating temperature and holding time during acid decomposition are set as follows.
A total of 3 μmL of nitric acid is added, normal temperature, 180° C. (5 μmin), 150° C. (1 μmin), 220° C. (2 μmin), 220° C. (maintained for 27 μmin), cooling to room temperature (25° C.).

The solution obtained above is adjusted to a constant volume of 50 μmL with ultrapure water. The resulting solution is further diluted 100 times with ultrapure water to obtain a measurement solution for ICP-MS.

### Quantitative Analysis of Boron Atoms in Toner Particle Using Inductively Coupled Plasma Mass Spectrometer

The content of boron atoms in the measurement solution for ICP-MS obtained above is quantified using the following device and conditions.
Device: Inductively coupled plasma mass spectrometer ICP-MS NexION 350D
PerkinElmer, Inc.
Measurement mode: standard mode, calibration curve method
Measurement element: boron
Mass number: 11.0093
Scan mode: peak hopping
Dwell time: 50 μms
Detector: dual
Peristaltic pump speed: 20.0 rpm

The content of boron atoms is thus quantified on the basis of the mass of the toner particle.

Method for Obtaining Toner Particle by Removing External Additive from Toner

A total of 160 g of sucrose (manufactured by Kishida Chemical Co., Ltd.) is added to 100 μmL of ion-exchanged water and dissolved using a hot water bath to prepare a concentrated sucrose solution. A total of 31 g of the concentrated sucrose solution and 6 μmL of Contaminon N (a 10% aqueous solution of a neutral detergent for cleaning precision measuring instruments that has pH 7 and consists of a nonionic surfactant, an anionic surfactant, and an organic builder, manufactured by Wako Pure Chemical Industries, Ltd.) are placed to a centrifuge tube (capacity 50 μmL). A total of 1.0 g of toner is added thereto, and the toner lumps are broken with a spatula or the like. The centrifuge tube is shaken with a shaker (AS-1N, sold by AS ONE Corporation) at 300 spm (strokes per minute) for 20 μmin. After shaking, the solution is transferred to a glass tube for a swing rotor (50 μmL) and separated in a centrifuge (H-9R, manufactured by Kokusan Co., Ltd.) at 3500 rpm for 30 μmin.

This operation separates the toner particle and the external additive. The separation of toner particle and the aqueous solution is visually confirmed to be sufficient, and the toner particle separated in the top layer are collected with a spatula or the like. The collected toner particle is filtered through a vacuum filter and then dried in a dryer for 1 h or more to obtain a measurement sample. This operation is carried out multiple times to ensure the required amount.

### EXAMPLES

The present disclosure will be described in more detail hereinbelow using examples and comparative examples. The present disclosure is not limited in any way by the following examples, unless otherwise specified. In the following description of the examples, “parts” are on the basis of mass, unless otherwise specified.

### Synthesis of Polyester Resin 1

| | |
|---|---|
| Bisphenol A - propylene oxide 2-mol adduct | 500 parts by mass |
| Bisphenol A - ethylene oxide 2-mol adduct | 460 parts by mass |
| Terephthalic acid | 330 parts by mass |
| Dodecenylsuccinic acid | 160 parts by mass |

The above monomers were added to a flask equipped with a stirrer, a nitrogen introduction tube, a temperature sensor, and a distillation column, the temperature was raised to 195° C. in 1 h, and it was confirmed that the reaction system was stirred uniformly. A total of 1.2 parts by mass of tin distearate was added to 100 parts of these monomers. The temperature was then raised from 195° C. to 240° C. over 5 h while distilling off the water produced, and a dehydration condensation reaction was carried out at 240° C. for another 2 h. The temperature was then lowered to 190° C., 40 parts by mass of trimellitic anhydride was gradually added, and the reaction was continued at 190° C. for 1 h.

As a result, polyester resin 1 was obtained with an acid value of 19.9 μmg KOH/g, a hydroxyl value of 31.7 μmg KOH/g, and a weight-average molecular weight of 32,000. The synthesis conditions and analysis results for polyester resin 1 are shown in Tables 1 and 2.

### Synthesis of Polyester Resins 2 to 9

Polyester resins 2 to 9 were obtained in the same manner as in the synthesis example of polyester resin 1, except that the raw materials used in the synthesis example of polyester resin 1 were changed as shown in Table 1. The synthesis conditions and analysis results for polyester resins 2 to 9 are shown in Tables 1 and 2.

TABLE 1

| | Raw materials charged (parts by mass) | | | | | | | |
|---|---|---|---|---|---|---|---|---|
| | Alcohol monomer | | | Acid monomer | | | | |
| | 1,2-Ethylene | BPA- | BPA- | Terephthalic | Dodecenylsuccinic | Isophthalic | Sebacic | Trimellitic |
| | glycol | 2PO | 2EO | acid | acid | acid | acid | acid |
| Polyester resin 1 | — | 500 | 460 | 330 | 160 | — | — | 40 |
| Polyester resin 2 | 50 | 500 | 410 | 330 | 310 | — | — | 40 |
| Polyester resin 3 | — | 500 | 460 | 330 | 85 | — | 75 | 30 |
| Polyester resin 4 | 50 | 500 | 410 | 420 | 220 | — | — | 30 |
| Polyester resin 5 | — | 500 | 460 | 280 | 50 | 50 | 110 | 30 |
| Polyester resin 6 | — | 500 | 460 | 280 | 40 | 50 | 120 | 30 |
| Polyester resin 7 | 50 | 500 | 410 | 330 | 350 | — | — | 30 |
| Polyester resin 8 | — | 500 | 460 | — | 160 | 330 | — | 40 |
| Polyester resin 9 | — | 500 | 460 | 300 | — | — | 160 | 40 |

BPA-2PO: Bisphenol A - propylene oxide 2-mol adduct
BPA-2EO: Bisphenol A - ethylene oxide 2-mol adduct

TABLE 2

| | Analysis results for polyester resins | | | |
|---|---|---|---|---|
| | Content of | Weight- | | |
| | dodecenylsuccinic | average | Acid | Hydroxyl |
| | acid | molecular | value | value |
| | (% by mass) | weight | mg KOH/g | mg KOH/g |
| Polyester | 10.7 | 32000 | 19.9 | 31.7 |
| resin 1 | | | | |
| Polyester | 18.9 | 30000 | 18.1 | 32.2 |
| resin 2 | | | | |
| Polyester | 5.7 | 31000 | 21.1 | 30.9 |
| resin 3 | | | | |
| Polyester | 13.5 | 32000 | 20.8 | 32.1 |
| resin 4 | | | | |
| Polyester | 3.4 | 33000 | 21.7 | 30.7 |
| resin 5 | | | | |
| Polyester | 2.7 | 31000 | 21.9 | 30.0 |
| resin 6 | | | | |
| Polyester | 21.0 | 30000 | 22.3 | 32.4 |
| resin 7 | | | | |
| Polyester | 10.7 | 35000 | 20.0 | 30.3 |
| resin 8 | | | | |
| Polyester | — | 32000 | 18.4 | 32.5 |
| resin 9 | | | | |

### Synthesis Example of Ester Wax 1

A total of 10 parts of ethylene glycol as an alcohol monomer and 100 parts of stearic acid as a carboxylic acid monomer were added to a reaction vessel equipped with a thermometer, a nitrogen introduction tube, a stirrer, a Dean-Stark trap, and a Dimroth condenser, and an esterification reaction was carried out at 200° C. for 15 h. A total of 20 parts of toluene and 25 parts of isopropanol were added to the obtained ester compound, 190 parts of a 10% potassium hydroxide aqueous solution equivalent to 1.5 times the acid value of the ester compound was added, and stirring was performed at 70° C. for 4 h. The water tank unit was then removed. A total of 20 parts of ion-exchanged water was added and stirred at 70° C. for 1 h, after which the water tank unit was removed and washed. The above washing step was repeated until the pH of the removed water tank became neutral.

The solvent was then removed under reduced pressure at 200° C. and 1 kPa to obtain ethylene glycol distearate (ester wax 1), which is an ester compound of ethylene glycol and stearic acid as the final product. The synthesis conditions and analysis results for the obtained ester wax 1 are shown in Tables 3 and 4.

### Production Examples of Ester Waxes 2 to 10

Ester waxes 2 to 10 were obtained in the same manner as in the synthesis example of ester wax 1, except that the raw materials used in the synthesis example of ester wax 1 were changed as shown in Table 3. The synthesis conditions and analysis results for the obtained ester waxes 2 to 10 are shown in Tables 3 and 4.

TABLE 3

| | | Alcohol | Raw material | Acid | Raw material |
|---|---|---|---|---|---|
| | Structure | monomer | (parts by mass) | monomer | (parts by mass) |
| Ester wax 1 | Ethylene glycol | Ethylene glycol | 10 | Stearic acid | 100 |
| | distearate | | | | |
| Ester wax 2 | 1,10-Decanediol | 1,10-Decanediol | 30 | Triacontanoic | 170 |
| | ditriacontanoate | | | acid | |
| Ester wax 3 | Behenyl sebacate | Behenyl alcohol | 120 | Sebacic acid | 35 |
| Ester wax 4 | Ethylene glycol | Ethylene glycol | 10 | Behenic acid | 120 |
| | dibehenate | | | | |
| Ester wax 5 | 1,6-Hexanediol | 1,6-Hexanediol | 20 | Stearic acid | 105 |
| | distearate | | | | |
| Ester wax 6 | Ethylene glycol | Ethylene glycol | 10 | Palmitic acid | 90 |
| | dipalmitate | | | | |
| Ester wax 7 | Pentaerythritol | Pentaerythritol | 20 | Palmitic acid | 160 |
| | tetrapalmitate | | | | |
| Ester wax 8 | Dipentaerythritol | Dipentaerythritol | 40 | Stearic acid | 280 |
| | hexastearate | | | | |
| Ester wax 9 | Behenyl behenate | Behenyl alcohol | 50 | Behenic acid | 50 |
| Ester wax 10 | Dipentaerythritol | Dipentaerythritol | 40 | Palmitic acid | 250 |
| | hexapalmitate | | | | |

TABLE 4

| | | | Molecular | Melting |
|---|---|---|---|---|
| | Structure | SP value | weight | point |
| Ester wax 1 | Ethylene glycol | 8.85 | 595 | 79° C. |
| | distearate | | | |
| Ester wax 2 | 1,10-Decanediol | 8.72 | 1045 | 88° C. |
| | ditriacontanoate | | | |
| Ester wax 3 | Behenyl sebacate | 8.77 | 819 | 73° C. |
| Ester wax 4 | Ethylene glycol | 8.81 | 707 | 84° C. |
| | dibehenate | | | |
| Ester wax 5 | 1,6-Hexanediol | 8.83 | 651 | 63° C. |
| | distearate | | | |
| Ester wax 6 | Ethylene glycol | 8.88 | 539 | 77° C. |
| | dipalmitate | | | |
| Ester wax 7 | Pentaerythritol | 8.97 | 1090 | 69° C. |
| | tetrapalmitate | | | |
| Ester wax 8 | Dipentaerythritol | 8.97 | 1853 | 77° C. |
| | hexastearate | | | |
| Ester wax 9 | Behenyl behenate | 8.59 | 649 | 72° C. |
| Ester wax 10 | Dipentaerythritol | 9.01 | 1685 | 72° C. |
| | hexapalmitate | | | |

The unit of SP value is (cal/cm³)^{0.5}.

### Synthesis of Compound A1

A total of 280 parts by mass of 1-dodecanol and 15.5 parts by mass of potassium hydroxide were charged into a 2 L autoclave, and after dehydration at 115° C. and 10.5 kPa, 720 parts by mass of ethylene oxide was added at 150° C. under a pressure of 0.3 MPa, and the addition reaction was carried out. After completion of the reaction, aging was performed at the same reaction temperature for 6 h followed by cooling to 80° C. A total of 250 parts by mass of a synthetic adsorbent (Kyoward 600S, manufactured by Kyowa Chemical Industry Co., Ltd.,) was added to the resulting reaction composition, and the mixture was treated at 4.0 kPa for 1 h, after which the catalyst was removed by filtration to obtain compound A1 shown in Table 5.

### Synthesis of Compounds A2 to A9, A11, and A13 to A16

Compounds A2 to A9, A11, and A13 to A16 were obtained in the same manner as in the synthesis example of compound A1, except that the raw materials used in the synthesis example of compound A1 were changed as shown in Table 3. Compounds A2 to A9, A11, and A13 to A16 are shown in Table 5.

### Synthesis of Compound A10

A total of 100 parts by mass of compound A1, 5 parts by mass of 5% Pt-1% Bi/C (Lot. TP-2/0230, manufactured by Evonik Co.) as a catalyst, and 420 parts by mass of ion-exchanged water were added to a 1000 μmL five-neck flask equipped with a reflux tube, a dissolved oxygen concentration meter, and a stirring blade. Next, the temperature was raised to 70° C. under nitrogen flow while stirring at 400 rpm, and nitrogen was continuously caused to flow for 15 μmin after reaching 70° C. After that, the flow was switched to oxygen and the oxygen flow was continued at 90 μmL/min for 18 h to induce reaction, obtaining compound A10. Regarding compound A10, see Table 5.

### Synthesis of Compound A12

A total of 100 parts by mass of compound A11, 5 parts by mass of 5% Pt-1% Bi/C (Lot. TP-2/0230, manufactured by Evonik Co.) as a catalyst, and 420 parts by mass of ion-exchanged water were added to a 1000 μmL five-neck flask equipped with a reflux tube, a dissolved oxygen concentration meter, and a stirring blade. Next, the temperature was raised to 70° C. under nitrogen flow while stirring at 400 rpm, and nitrogen was continuously caused to flow for 15 μmin after reaching 70° C. After that, the flow was switched to oxygen and the oxygen flow was continued at 90 μmL/min for 18 h to induce reaction, obtaining compound A12. Regarding compound A12, see Table 5.

TABLE 5

| | | Raw material | | | Structure of compound A | | |
|---|---|---|---|---|---|---|---|
| | | | Alkyl alcohol | Ethylene | Number of | Average number | |
| | | Alkyl alcohol | (parts by | oxide (parts | carbon atoms | of added moles | Structure |
| | | (type) | mass) | by mass) | in R¹ or R² | (n or m) | of X |
| Compound A1 | Formula (1) | 1-Dodecanol | 280 | 720 | 12 | 10 | H |
| Compound A2 | Formula (1) | 1-Octanol | 350 | 650 | 8 | 5 | H |
| Compound A3 | Formula (1) | 1-Octanol | 280 | 720 | 8 | 7 | H |
| Compound A4 | Formula (1) | 1-Decanol | 250 | 750 | 10 | 10 | H |
| Compound A5 | Formula (1) | 1-Dodecanol | 180 | 820 | 12 | 19 | H |
| Compound A6 | Formula (1) | 1-Octadecanol | 200 | 800 | 18 | 23 | H |
| Compound A7 | Formula (1) | 1-Octadecanol | 150 | 850 | 18 | 32 | H |
| Compound A8 | Formula (1) | 1-Tetracosanol | 200 | 800 | 24 | 30 | H |
| Compound A9 | Formula (1) | 1-Tetracosanol | 130 | 870 | 24 | 51 | H |
| Compound A10 | Formula (1) | 1-Dodecanol | 280 | 720 | 12 | 9 | CH₂COOH |
| Compound A11 | Formula (2) | 4-Dodecylphenol | 280 | 720 | 12 | 10 | H |
| Compound A12 | Formula (2) | 4-Dodecylphenol | 280 | 720 | 12 | 9 | CH₂COOH |
| Compound A13 | Formula (1) | 1-Tetracosanol | 110 | 890 | 24 | 62 | H |
| Compound A14 | Formula (1) | 1-Myricylnol | 220 | 780 | 30 | 33 | H |
| Compound A15 | Formula (1) | 1-Butanol | 160 | 840 | 4 | 8 | H |
| Compound A16 | Formula (1) | 1-Octanol | 400 | 600 | 8 | 4 | H |

In compounds A2 to A16, A1 and A2 are ethylene groups.

### Preparation of Resin Particle Dispersion Liquid of Polyester Resin 1

A total of 50 parts by mass of the above methyl ethyl ketone and 20 parts by mass of isopropyl alcohol were added to a container. Then, 100 parts by mass of polyester resin 1 was gradually added and stirred for complete dissolution, thereby obtaining a polyester resin 1 solution. The container containing the polyester resin 1 solution was set to 65° C., 10% aqueous ammonia was gradually added dropwise, while stirring, to a total of 5 parts, and 230 parts of ion-exchanged water was gradually added dropwise at a rate of 10 mL/mm to cause phase inversion emulsification. The pressure was then reduced using an evaporator to remove the solvent, and a resin particle dispersion liquid of polyester resin 1 was obtained. The particle diameter of this resin particle dispersion liquid of polyester resin 1 was measured using a particle diameter measuring device (LA-950, manufactured by Horiba, Ltd.), and the volume-average particle diameter of the resin particle dispersion liquid of polyester resin 1 was 105 nm. The solid fraction amount in the resin particle dispersion liquid of polyester resin 1 was adjusted to 20% by mass with ion-exchanged water.

### Preparation of Resin Particle Dispersion Liquid of Polyester Resin 2 to Resin Particle Dispersion Liquid of Polyester Resin 9

A resin particle dispersion liquid of polyester resin 2 to a resin particle dispersion liquid of polyester resin 9 were prepared in the same manner as in the preparation of the resin particle dispersion liquid of polyester resin 1, except that the polyester resin 1 was replaced with polyester resins 2 to 9.

### Preparation of Colorant Particle Dispersion Liquid

| | | |
|---|---|---|
| Copper phthalocyanine (Pigment Blue 15:3) | 45 | parts |
| Ionic surfactant Neogen RK | 5 | parts |
| (manufactured by DKS Co., Ltd.) | | |
| Ion-exchanged water | 190 | parts |

The above components were mixed and dispersed for 1 h using a high-pressure impact disperser Nanomizer (manufactured by Yoshida Kikai Kogyo Co., Ltd.) to prepare an aqueous dispersion liquid (colorant particle dispersion liquid) with a concentration of 20% by mass of colorant fine particles in which the colorant was dispersed.

### Preparation of Hydrocarbon Wax Particle Dispersion Liquid

| | | |
|---|---|---|
| Hydrocarbon wax | 45 | parts |
| (HNP-9, manufactured by Nippon Seiro Co., Ltd.) | | |
| Ionic surfactant Neogen RK | 5 | parts |
| (manufactured by DKS Co., Ltd.) | | |
| Ion-exchanged water | 190 | parts |

The above components were placed in a mixing vessel equipped with a stirrer, heated to 90° C., and subjected to dispersion treatment for 60 μmin by circulating through a Clearmix W Motion (manufactured by M Technique Co., Ltd.). The dispersion treatment conditions were as follows:
Rotor outer diameter: 3 cm
Clearance: 0.3 μmm
Rotor rotation speed: 19,000 r/min
Screen rotation speed 19,000 r/min

After the dispersion treatment, cooling was performed to 40° C. under cooling conditions of a rotor rotation speed of 1000 r/min, a screen rotation speed of 0 r/min, and a cooling rate of 10° C./min to obtain a hydrocarbon wax dispersion liquid with a volume-average particle diameter of 160 nm and a solid fraction amount of 20% by mass.

### Preparation of Ester Wax Dispersion Liquid 1

| | | |
|---|---|---|
| Ester wax 1 | 45 | parts |
| Ionic surfactant Neogen RK | 5 | parts |
| (manufactured by DKS Co., Ltd.) | | |
| Ion-exchanged water | 190 | parts |

The above components were placed in a mixing vessel equipped with a stirrer, heated to 90° C., and subjected to dispersion treatment for 60 μmin by circulating through a Clearmix W Motion (manufactured by M Technique Co., Ltd.). The dispersion treatment conditions were as follows:
Rotor outer diameter: 3 cm
Clearance: 0.3 μmm
Rotor rotation speed: 19,000 r/min
Screen rotation speed 19,000 r/min

After the dispersion treatment, cooling was performed to 40° C. under cooling conditions of a rotor rotation speed of 1000 r/min, a screen rotation speed of 0 r/min, and a cooling rate of 10° C./min to obtain an ester wax dispersion liquid 1 with a volume-average particle diameter of 170 nm and a solid fraction amount of 20% by mass.

### Preparation of Ester Wax Dispersion Liquids 2 to 10

Ester wax dispersion liquids 2 to 10 were obtained in the same manner as in preparation of ester wax dispersion liquid 1, except that the ester wax 1 was replaced with ester waxes 2 to 10.

### Production of Toner Particle 1

| | | |
|---|---|---|
| Resin particle dispersion liquid of polyester resin 1 | 750 | parts |
| Colorant particle dispersion liquid | 70 | parts |
| Hydrocarbon wax dispersion liquid 1 | 30 | parts |
| Ester wax dispersion liquid 1 | 130 | parts |
| Ion-exchanged water | 1000 | parts |

First, in the core formation step, the above materials were placed in a round stainless steel flask and mixed. Then, a homogenizer Ultra Turrax T50 (manufactured by IKA Works, Inc.) was used to disperse the mixture at 5000 r/min for 10 μmin. After adding a 1.0% aqueous nitric acid solution and adjusting the pH to 3.0, the mixture was heated to 45° C. in a heated water bath while appropriately adjusting the rotation speed so that the mixture was stirred using a stirring blade.

The volume-average particle diameter of the formed aggregated particles was confirmed, as appropriate, using a Coulter Multisizer 3, and when aggregated particles (cores) of 5.0 μm were formed, the following materials were added as the shell formation step and stirred for another hour to form a shell.

| | | |
|---|---|---|
| Resin particle dispersion liquid of polyester resin 1 | 250 | parts |
| Ion-exchanged water | 300 | parts |
| 3.0% by mass aqueous solution of compound A1 | 100 | parts |
| 2.0% by mass aqueous solution of borax | 50 | parts |

(Borax: sodium tetraborate decahydrate, manufactured by Fujifilm Wako Pure Chemical Industries, Ltd.)

Then, as the sphering step, the pH was adjusted to 9.0 using a 5% aqueous solution of sodium hydroxide, and the mixture was heated to 90° C. while continuing to stir.

The average circularity of the formed aggregated particles was then measured, as appropriate, using a flow type particle image analyzer “FPIA-3000” (manufactured by Sysmex Corporation).

Heating was then performed until the average circularity of the aggregated particles reached 0.970 (heating time was 3 h), and then, as a cooling step, ice was quickly added so that the cooling rate was 10° C./sec or more, thereby cooling to 25° C. to obtain a dispersion liquid of toner particle 1.

The dispersion liquid of toner particle 1 was neutralized by adding hydrochloric acid to adjust the pH to 5.0 to 7.0, and then subjected to solid-liquid separation at a pressure of 0.3 MPa in a pressure filter to obtain a toner cake. This was re-slurried with ion-exchanged water to make a dispersion liquid again, and then subjected to solid-liquid separation at a pressure of 0.3 MPa in the aforementioned filter to obtain a toner cake. Furthermore, 2000 parts by mass of ion-exchanged water was added to the toner cake, and washing was performed while removing water by pressurizing again to 0.3 MPa. Further, after air drying while maintaining 0.2 MPa, the toner cake was taken out and subjected to crushing treatment.

The toner cake subjected to crushing treatment was dried in a vacuum dryer at 40° C. for 12 h, and then classified to obtain toner particle 1. The production conditions and analysis results for toner particle 1 are shown in Tables 6 and 7.

### Production of Toner Particles 2 to 45 and Comparative Toner Particles 1 to 11

Toner particles 2 to 45 and comparative toner particles 1 to 11 were obtained in the same manner as in the production of toner particle 1, except that the conditions were changed to those shown in Table 4. The production conditions and analysis results for toner particles 2 to 45 and comparative toner particles 1 to 11 are shown in Tables 6 and 7.

TABLE 6

| | Core formation | | | | | Shell formation | | | | |
|---|---|---|---|---|---|---|---|---|---|---|
| Toner | | | Hydrocarbon | | | | | | | Borate |
| particle | Polyester resin | | wax | Ester wax | | Polyester resin | | Compound A | | (parts |
| No. | Type | Parts | Parts | Type | Parts | Type | Parts | Type | Parts | by mass) |
| 1 | 1 | 750 | 30 | 1 | 130 | 1 | 250 | 1 | 100 | 50 |
| 2 | 1 | 750 | 30 | 1 | 130 | 1 | 250 | 2 | 100 | 50 |
| 3 | 1 | 750 | 30 | 1 | 130 | 1 | 250 | 3 | 100 | 50 |
| 4 | 1 | 750 | 30 | 1 | 130 | 1 | 250 | 4 | 100 | 50 |
| 5 | 1 | 750 | 30 | 1 | 130 | 1 | 250 | 5 | 100 | 50 |
| 6 | 1 | 750 | 30 | 1 | 130 | 1 | 250 | 6 | 100 | 50 |
| 7 | 1 | 750 | 30 | 1 | 130 | 1 | 250 | 7 | 100 | 50 |
| 8 | 1 | 750 | 30 | 1 | 130 | 1 | 250 | 8 | 100 | 50 |
| 9 | 1 | 750 | 30 | 1 | 130 | 1 | 250 | 9 | 100 | 50 |
| 10 | 1 | 750 | 30 | 1 | 130 | 1 | 250 | 10 | 100 | 50 |
| 11 | 1 | 750 | 30 | 1 | 130 | 1 | 250 | 11 | 100 | 50 |
| 12 | 1 | 750 | 30 | 1 | 130 | 1 | 250 | 12 | 100 | 50 |
| 13 | 1 | 750 | 30 | 2 | 130 | 1 | 250 | 1 | 100 | 50 |
| 14 | 1 | 750 | 30 | 3 | 130 | 1 | 250 | 1 | 100 | 50 |
| 15 | 1 | 750 | 30 | 4 | 130 | 1 | 250 | 1 | 100 | 50 |
| 16 | 1 | 750 | 30 | 5 | 130 | 1 | 250 | 1 | 100 | 50 |
| 17 | 1 | 750 | 30 | 6 | 130 | 1 | 250 | 1 | 100 | 50 |
| 18 | 1 | 750 | 30 | 7 | 130 | 1 | 250 | 1 | 100 | 50 |
| 19 | 1 | 750 | 30 | 8 | 130 | 1 | 250 | 1 | 100 | 50 |
| 20 | 1 | 750 | — | 1 | 130 | 1 | 250 | 1 | 100 | 50 |
| 21 | 1 | 750 | 40 | 1 | 25 | 1 | 250 | 1 | 100 | 50 |
| 22 | 1 | 750 | 40 | 1 | 35 | 1 | 250 | 1 | 100 | 50 |
| 23 | 1 | 750 | 30 | 1 | 105 | 1 | 250 | 1 | 100 | 50 |
| 24 | 1 | 750 | 30 | 1 | 140 | 1 | 250 | 1 | 100 | 50 |
| 25 | 1 | 750 | 30 | 1 | 200 | 1 | 250 | 1 | 100 | 50 |
| 26 | 1 | 750 | 30 | 1 | 250 | 1 | 250 | 1 | 100 | 50 |
| 27 | 6 | 750 | 30 | 1 | 130 | 6 | 250 | 1 | 100 | 50 |
| 28 | 5 | 750 | 30 | 1 | 130 | 5 | 250 | 1 | 100 | 50 |
| 29 | 3 | 750 | 30 | 1 | 130 | 3 | 250 | 1 | 100 | 50 |
| 30 | 4 | 750 | 30 | 1 | 130 | 4 | 250 | 1 | 100 | 50 |
| 31 | 2 | 750 | 30 | 1 | 130 | 2 | 250 | 1 | 100 | 50 |
| 32 | 7 | 750 | 30 | 1 | 130 | 7 | 250 | 1 | 100 | 50 |
| 33 | 8 | 750 | 30 | 1 | 130 | 8 | 250 | 1 | 100 | 50 |
| 34 | 1 | 750 | 30 | 1 | 130 | 1 | 250 | 1 | 7 | 50 |
| 35 | 1 | 750 | 30 | 1 | 130 | 1 | 250 | 1 | 15 | 50 |
| 36 | 1 | 750 | 30 | 1 | 130 | 1 | 250 | 1 | 25 | 50 |
| 37 | 1 | 750 | 30 | 1 | 130 | 1 | 250 | 1 | 150 | 50 |
| 38 | 1 | 750 | 30 | 1 | 130 | 1 | 250 | 1 | 250 | 50 |
| 39 | 1 | 750 | 30 | 1 | 130 | 1 | 250 | 1 | 400 | 50 |
| 40 | 1 | 750 | 30 | 1 | 130 | 1 | 250 | 1 | 600 | 50 |
| 41 | 1 | 750 | 30 | 1 | 130 | 1 | 250 | 1 | 100 | 30 |
| 42 | 1 | 750 | 30 | 1 | 130 | 1 | 250 | 1 | 100 | — |
| 43 | 1 | 900 | 30 | 1 | 130 | 1 | 100 | 1 | 100 | — |
| 44 | 1 | 500 | 30 | 1 | 130 | 1 | 500 | 1 | 100 | 200 |
| 45 | 1 | 500 | 30 | 1 | 130 | 1 | 500 | 1 | 100 | 350 |
| Comparative 1 | 9 | 750 | 30 | 1 | 130 | 9 | 250 | 1 | 100 | 50 |
| Comparative 2 | 1 | 750 | 30 | 9 | 130 | 1 | 250 | 1 | 100 | 50 |
| Comparative 3 | 1 | 750 | 30 | 10 | 130 | 1 | 250 | 1 | 100 | 50 |
| Comparative 4 | 1 | 750 | 30 | — | — | 1 | 250 | 1 | 100 | 50 |
| Comparative 5 | 1 | 750 | 30 | 1 | 130 | 1 | 250 | 13 | 100 | 50 |
| Comparative 6 | 1 | 750 | 30 | 1 | 130 | 1 | 250 | 14 | 100 | 50 |
| Comparative 7 | 1 | 750 | 30 | 1 | 130 | 1 | 250 | 15 | 100 | 50 |
| Comparative 8 | 1 | 750 | 30 | 1 | 130 | 1 | 250 | 16 | 100 | 50 |
| Comparative 9 | 1 | 750 | 30 | 1 | 130 | 1 | 250 | — | — | 50 |
| Comparative 10 | 1 | 750 | 30 | 1 | 130 | 1 | 250 | SDBS | 100 | 50 |
| Comparative 11 | 9 | 750 | 30 | 1 | 130 | 9 | 250 | SDBS | 100 | 50 |

In the table, the number of parts indicates the number of parts by mass of each dispersion liquid and aqueous solution. The number in the borax column indicates the number of parts by mass of a 2.0% by mass borax aqueous solution. SDBS indicates sodium dodecylbenzenesulfonate.

TABLE 7

| | | Amount of | | | | | |
|---|---|---|---|---|---|---|---|
| Toner | Toner | dodecenylsuccinic | | | Content of | | Content of |
| particle | D4 | acid in binder resin | Ester wax | | compound A | As | boron atoms |
| No. | (μm) | (% by mass) | Type | Content | (ppm) | (% by area) | (ppm) |
| 1 | 6.6 | 10.7 | 1 | 13.0 | 120 | 0.1 | 5.1 |
| 2 | 6.8 | 10.7 | 1 | 13.0 | 120 | 0.0 | 5.0 |
| 3 | 6.7 | 10.7 | 1 | 13.0 | 120 | 0.1 | 5.1 |
| 4 | 6.6 | 10.7 | 1 | 13.0 | 120 | 0.0 | 5.1 |
| 5 | 6.7 | 10.7 | 1 | 13.0 | 120 | 0.0 | 5.2 |
| 6 | 6.7 | 10.7 | 1 | 13.0 | 120 | 0.1 | 5.1 |
| 7 | 6.7 | 10.7 | 1 | 13.0 | 120 | 0.0 | 5.3 |
| 8 | 6.7 | 10.7 | 1 | 13.0 | 120 | 0.0 | 5.0 |
| 9 | 6.7 | 10.7 | 1 | 13.0 | 120 | 0.0 | 5.1 |
| 10 | 6.7 | 10.7 | 1 | 13.0 | 120 | 0.1 | 5.0 |
| 11 | 6.7 | 10.7 | 1 | 13.0 | 120 | 0.1 | 5.1 |
| 12 | 6.7 | 10.7 | 1 | 13.0 | 120 | 0.1 | 5.1 |
| 13 | 6.7 | 10.7 | 2 | 13.0 | 120 | 0.0 | 5.1 |
| 14 | 6.8 | 10.7 | 3 | 13.0 | 120 | 0.1 | 5.2 |
| 15 | 6.6 | 10.7 | 4 | 13.0 | 120 | 0.0 | 5.1 |
| 16 | 6.7 | 10.7 | 5 | 13.0 | 120 | 0.1 | 5.1 |
| 17 | 6.7 | 10.7 | 6 | 13.0 | 120 | 0.0 | 5.2 |
| 18 | 6.7 | 10.7 | 7 | 13.0 | 120 | 0.0 | 5.0 |
| 19 | 6.7 | 10.7 | 8 | 13.0 | 120 | 0.1 | 5.1 |
| 20 | 6.7 | 10.7 | 1 | 13.0 | 120 | 0.1 | 5.1 |
| 21 | 6.8 | 10.7 | 1 | 2.5 | 120 | 0.0 | 5.0 |
| 22 | 6.8 | 10.7 | 1 | 3.5 | 120 | 0.0 | 5.1 |
| 23 | 6.8 | 10.7 | 1 | 10.5 | 120 | 0.1 | 5.3 |
| 24 | 6.6 | 10.7 | 1 | 14.0 | 120 | 0.0 | 5.2 |
| 25 | 6.7 | 10.7 | 1 | 18.0 | 120 | 0.0 | 5.2 |
| 26 | 6.7 | 10.7 | 1 | 25.0 | 120 | 0.0 | 5.1 |
| 27 | 6.6 | 2.7 | 1 | 13.0 | 120 | 0.1 | 5.0 |
| 28 | 6.7 | 3.4 | 1 | 13.0 | 120 | 0.0 | 5.1 |
| 29 | 6.7 | 5.7 | 1 | 13.0 | 120 | 0.1 | 5.0 |
| 30 | 6.6 | 13.5 | 1 | 13.0 | 120 | 0.1 | 5.1 |
| 31 | 6.7 | 18.9 | 1 | 13.0 | 120 | 0.0 | 5.1 |
| 32 | 6.7 | 21.0 | 1 | 13.0 | 120 | 0.0 | 5.2 |
| 33 | 6.8 | 10.7 | 1 | 13.0 | 120 | 0.0 | 5.1 |
| 34 | 6.6 | 10.7 | 1 | 13.0 | 15 | 0.1 | 5.3 |
| 35 | 6.7 | 10.7 | 1 | 13.0 | 35 | 0.0 | 5.0 |
| 36 | 6.6 | 10.7 | 1 | 13.0 | 55 | 0.0 | 5.1 |
| 37 | 6.6 | 10.7 | 1 | 13.0 | 280 | 0.0 | 5.1 |
| 38 | 6.6 | 10.7 | 1 | 13.0 | 450 | 0.1 | 5.1 |
| 39 | 6.6 | 10.7 | 1 | 13.0 | 800 | 0.0 | 5.2 |
| 40 | 6.7 | 10.7 | 1 | 13.0 | 1200 | 0.1 | 5.2 |
| 41 | 6.8 | 10.7 | 1 | 13.0 | 120 | 0.4 | 2.0 |
| 42 | 6.6 | 10.7 | 1 | 13.0 | 120 | 0.8 | — |
| 43 | 6.6 | 10.7 | 1 | 13.0 | 120 | 1.8 | — |
| 44 | 6.7 | 10.7 | 1 | 13.0 | 120 | 0.0 | 30.7 |
| 45 | 6.6 | 10.7 | 1 | 13.0 | 120 | 0.0 | 53.4 |
| Comparative 1 | 6.6 | — | 1 | 13.0 | 120 | 0.0 | 5.1 |
| Comparative 2 | 6.6 | 10.7 | 9 | 13.0 | 120 | 0.1 | 5.1 |
| Comparative 3 | 6.7 | 10.7 | 10 | 13.0 | 120 | 0.1 | 5.1 |
| Comparative 4 | 6.8 | 10.7 | — | — | 120 | — | 5.2 |
| Comparative 5 | 6.7 | 10.7 | 1 | 13.0 | 120 | 0.0 | 5.1 |
| Comparative 6 | 6.6 | 10.7 | 1 | 13.0 | 120 | 0.1 | 5.2 |
| Comparative 7 | 6.7 | 10.7 | 1 | 13.0 | 120 | 0.0 | 5.1 |
| Comparative 8 | 6.6 | 10.7 | 1 | 13.0 | 120 | 0.1 | 5.2 |
| Comparative 9 | 6.6 | 10.7 | 1 | 13.0 | — | 0.0 | 5.1 |
| Comparative 10 | 6.6 | 10.7 | 1 | 13.0 | SDBS 120 | 0.0 | 5.1 |
| Comparative 11 | 6.6 | — | 1 | 13.0 | SDBS 120 | 0.0 | 5.1 |

In the table, the amount of dodecenylsuccinic acid in the binder resin indicates the content ratio of the monomer unit corresponding to dodecenylsuccinic acid based on the mass of the binder resin. The content of ester wax indicates the number of parts by mass relative to 100 parts by mass of the binder resin. The content of compound A indicates the extraction amount of compound A extracted from the toner with ethanol based on the mass of the toner. The content of boron atoms indicates the content of boron atoms based on the mass of the toner particle.

### Example 1

| | | |
|---|---|---|
| Toner particle 1 | 100.0 | parts |
| RX10 (manufactured by Nippon Aerosil Co., Ltd.) | 2.0 | parts |
| RX200 (manufactured by Nippon Aerosil Co., Ltd.) | 1.5 | parts |

The above materials were mixed at 3000 rpm for 7.5 μmin using a Henschel mixer FM10C (manufactured by Nippon Coke Co., Ltd.) to obtain toner 1.

The obtained toner 1 was evaluated according to the following procedures.

### Evaluation Methods

### Evaluation of Low-Temperature Fixability

A process cartridge filled with toner 1 was allowed to stand for 48 h at a temperature of 25° C. and a humidity of 40% RH. An LBP-712Ci modified to enable operation even when the fixing unit was removed was used, and an unfixed image of an image pattern in which 10 μmm×10 μmm square images were evenly arranged in 9 points over the entire transfer paper was output. The toner laid-on level on the transfer paper was 0.80 μmg/cm², and the fixing lower limit temperature and fixing upper limit temperature were evaluated while changing the fixing temperature in 5° C. intervals within a range from 100° C. to 220° C. The transfer paper used was A4 paper (“Prover Bond Paper”: 105 g/m², manufactured by Fox River Co.).

The fixing unit used was an external fixing unit that had been removed from the LBP-712Ci and modified to be capable to operate even outside of the laser beam printer. The fixing temperature of the external fixing unit was raised in 5° C. increments from 120° C., and fixing was performed under the condition of a process speed of 360 μmm/sec. The fixed image was visually checked, and the minimum temperature at which cold offset did not occur was taken as the fixing lower limit temperature.

### Evaluation of Density Stability and Density Uniformity

As an evaluation machine, a Color Laser Jet Enterprise 6701dn (manufactured by HP Inc.) was prepared and modified to allow the printing speed to be changed. Using a process cartridge filled with toner 1, a durability test was performed in which 15,000 sheets with horizontal lines with an image ratio of 1% were continuously passed (printed) at a printing speed of 75 sheets/min under an environment of normal temperature and normal humidity NN (25° C./50% RH), and then density stability and density uniformity were evaluated.

To evaluate density stability and density uniformity, after the durability test, a solid black image was output on the 1st sheet, a horizontal line image was output on the second to 99th sheets, and a solid black image was output again on the 100th sheet. For the 1st and 100th solid black images, image density was measured at a total of six points on the lines 10 cm and 20 cm from the top of the transfer material, as well as on the left, center, and right, and the average value was calculated. Density stability was evaluated from the difference between the average density value of the 1st sheet and the average density value of the 100th sheet.

In addition, for the 100th solid black image, image density uniformity was evaluated from the difference between the average values of image density at points at 1 cm and 10 cm from the top of the transfer material. A4-sized GF-C081 (manufactured by Canon Inc., 81.4 g/m²) was used as the transfer material, and density measurements were performed using an X-Rite eXact Advance (manufactured by X-Rite, Inc.).

The evaluation criteria are as follows:

### Criteria for Density Stability Evaluation

### (Evaluation Criteria)

A: The difference in average density between the 1st and 100th sheets is less than 0.04
B: The difference in average density between the 1st and 100th sheets is 0.04 or more and less than 0.07
C: The difference in average density between the 1st and 100th sheets is 0.07 or more and less than 0.10
D: The difference in average density between the 1st and 100th sheets is 0.10 or more

### Criteria for Density Uniformity Evaluation

### (Evaluation Criteria)

A: The difference in average image density between points at 1 cm and 10 cm from the top of the transfer material is less than 0.04
B: The difference in average image density between points at 1 cm and 10 cm from the top of the transfer material is 0.04 or more and less than 0.07
C: The difference in average image density between points at 1 cm and 10 cm from the top of the transfer material is 0.07 or more and less than 0.10
D: The difference in average image density between points at 1 cm and 10 cm from the top of the transfer material is 0.10 or more

As a result of evaluating toner 1, the density of the solid black image on both the 1st and 100th sheets was 1.40 or more, and the difference in the average density was less than 0.04, showing stability. Furthermore, for the solid black image on the 100th sheet, the difference in the average image density between points at 1 cm and 10 cm from the top edge of the transfer material was less than 0.04, showing excellent density uniformity. The evaluation results of Toner 1 are shown in Table 8.

TABLE 8

| | | Evaluation of | | |
|---|---|---|---|---|
| | | fixability, | | |
| | | fixing lower | Charging performance | |
| Example | Toner | limit temperature | Density | Density |
| No. | particle | (° C.) | stability | uniformity |
| 1 | 1 | 130 | 0.01 | 0.01 |
| 2 | 2 | 135 | 0.03 | 0.07 |
| 3 | 3 | 135 | 0.03 | 0.06 |
| 4 | 4 | 130 | 0.02 | 0.03 |
| 5 | 5 | 130 | 0.02 | 0.02 |
| 6 | 6 | 130 | 0.05 | 0.02 |
| 7 | 7 | 130 | 0.06 | 0.01 |
| 8 | 8 | 135 | 0.07 | 0.02 |
| 9 | 9 | 140 | 0.09 | 0.02 |
| 10 | 10 | 130 | 0.01 | 0.03 |
| 11 | 11 | 135 | 0.02 | 0.01 |
| 12 | 12 | 135 | 0.01 | 0.03 |
| 13 | 13 | 165 | 0.09 | 0.07 |
| 14 | 14 | 150 | 0.06 | 0.06 |
| 15 | 15 | 145 | 0.04 | 0.02 |
| 16 | 16 | 140 | 0.03 | 0.02 |
| 17 | 17 | 135 | 0.04 | 0.02 |
| 18 | 18 | 170 | 0.05 | 0.07 |
| 19 | 19 | 175 | 0.06 | 0.08 |
| 20 | 20 | 135 | 0.01 | 0.02 |
| 21 | 21 | 170 | 0.03 | 0.07 |
| 22 | 22 | 160 | 0.03 | 0.06 |
| 23 | 23 | 140 | 0.02 | 0.02 |
| 24 | 24 | 130 | 0.02 | 0.03 |
| 25 | 25 | 125 | 0.05 | 0.03 |
| 26 | 26 | 125 | 0.08 | 0.03 |
| 27 | 27 | 165 | 0.02 | 0.09 |
| 28 | 28 | 160 | 0.02 | 0.08 |
| 29 | 29 | 145 | 0.02 | 0.06 |
| 30 | 30 | 130 | 0.03 | 0.03 |
| 31 | 31 | 125 | 0.06 | 0.02 |
| 32 | 32 | 125 | 0.07 | 0.02 |
| 33 | 33 | 130 | 0.01 | 0.01 |
| 34 | 34 | 140 | 0.01 | 0.08 |
| 35 | 35 | 140 | 0.02 | 0.06 |
| 36 | 36 | 135 | 0.02 | 0.05 |
| 37 | 37 | 130 | 0.03 | 0.02 |
| 38 | 38 | 130 | 0.04 | 0.01 |
| 39 | 39 | 125 | 0.06 | 0.01 |
| 40 | 40 | 125 | 0.09 | 0.01 |
| 41 | 41 | 130 | 0.03 | 0.03 |
| 42 | 42 | 130 | 0.04 | 0.06 |
| 43 | 43 | 125 | 0.06 | 0.09 |
| 44 | 44 | 140 | 0.01 | 0.05 |
| 45 | 45 | 150 | 0.02 | 0.06 |
| Comparative | Comparative | 190 | 0.07 | 0.08 |
| 1 | 1 | | | |
| Comparative | Comparative | 170 | 0.15 | 0.14 |
| 2 | 2 | | | |
| Comparative | Comparative | 180 | 0.03 | 0.09 |
| 3 | 3 | | | |
| Comparative | Comparative | 185 | 0.01 | 0.06 |
| 4 | 4 | | | |
| Comparative | Comparative | 145 | 0.14 | 0.02 |
| 5 | 5 | | | |
| Comparative | Comparative | 140 | 0.15 | 0.02 |
| 6 | 6 | | | |
| Comparative | Comparative | 140 | 0.02 | 0.14 |
| 7 | 7 | | | |
| Comparative | Comparative | 140 | 0.02 | 0.16 |
| 8 | 8 | | | |
| Comparative | Comparative | 145 | 0.03 | 0.17 |
| 9 | 9 | | | |
| Comparative | Comparative | 170 | 0.16 | 0.19 |
| 10 | 10 | | | |
| Comparative | Comparative | 190 | 0.18 | 0.20 |
| 11 | 11 | | | |

### Examples 2 to 45 and Comparative Examples 1 to 11

Table 8 shows the evaluation results for Examples 2 to 45 and Comparative Examples 1 to 11, which were obtained in the same manner as in Example 1.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-215482, fled Dec. 21, 2023 which is hereby incorporated by reference herein its entirety.

What is claimed is:

1. A toner comprising a toner particle comprising a binder resin, wherein
the toner particle comprises an ester wax, and a compound A, which is at least one compound selected from the group consisting of compounds represented by a following formula (1) and compounds represented by a following formula (2),
the binder resin comprises a polyester resin,
the polyester resin comprises a monomer unit corresponding to dodecenylsuccinic acid, and
the ester wax has an SP value (cal/cm³)^{0.5} of 8.70 to 9.00
R¹—O-(A1-O)ₙ-X (1)
In formula (1), R¹ represents an alkyl group having 8 to 24 carbon atoms, A1 represents an ethylene group or a propylene group, n is an integer from 5 to 60, and X is H, CH₂COOH, CH₂SO₃H, CH₂COONa, or CH₂SO₃Na
R²-Ph—O-(A2-O)ₘ-X (2)
In formula (2), R² represents an alkyl group having 8 to 24 carbon atoms, Ph represents a phenylene group, A2 represents an ethylene group or a propylene group, m is an integer from 5 to 60, and X is H, CH₂COOH, CH₂SO₃H, CH₂COONa, or CH₂SO₃Na.

2. The toner according to claim 1, wherein the ester wax has a molecular weight of 500 to 1000.

3. The toner according to claim 1, wherein the content of the ester wax in the toner is from 3.0 parts by mass to 20.0 parts by mass per 100 parts by mass of the binder resin.

4. The toner according to claim 1, wherein the content ratio of the monomer unit corresponding to dodecenylsuccinic acid based on the mass of the binder resin is from 3.0% by mass to 20.0% by mass.

5. The toner according to claim 1, wherein an extraction amount of the compound A extracted from the toner with ethanol based on the mass of the toner is from 10 ppm to 1000 ppm.

6. The toner according to claim 1, wherein
the content of the ester wax in the toner is from 3.0 parts by mass to 20.0 parts by mass per 100 parts by mass of the binder resin,
the content ratio of the monomer unit corresponding to dodecenylsuccinic acid based on the mass of the binder resin is from 3.0% by mass to 20.0% by mass, and
an extraction amount of the compound A extracted from the toner with ethanol based on the mass of the toner is from 10 ppm to 1000 ppm.

7. The toner according to claim 1, wherein the ester wax comprises a compound represented by a following formula (3)
R³—COO—R⁵—OCO—R⁴ (3)
R³ and R⁴ each independently represent an alkyl group having 17 to 22 carbon atoms, and R⁵ represents an alkylene group having 2 to 6 carbon atoms.

8. The toner according to claim 1, wherein
in cross-sectional observation of the toner using a transmission electron microscope,
where an average ratio of an area occupied by domains of a wax, comprising the ester wax, in a surface layer region from the surface of the toner particle to a depth of 200 nm is defined as As,
As is from 0.0% by area to 1.0% by area.

9. The toner according to claim 1, wherein the toner particle comprises boron atoms, and the content of the boron atoms based on the mass of the toner particle is from 1.0 ppm to 50.0 ppm.

10. The toner according to claim 1, wherein the content ratio of the polyester resin based on the mass of the binder resin is from 50.0% by mass to 100.0% by mass.
